(19) United States
(12) Patent Application Publication
(10) Pub. No.: US 2011/0004596 A1
(43) Pub. Date: Jan. 6, 2011

(54) HIERARCHICAL ITEM IDENTIFICATION SYSTEM (HIIS)

(76) Inventors: Tyler Gildred, Santa Ynez, CA (US); Travis Purdy, Shell Beach, CA (US)

Correspondence Address: Cislo & Thomas LLP, 1333 2nd Street, Suite #500, Santa Monica, CA, 90401-4110, US

(21) Appl. No.: 12/830,266

(22) Filed: Jul. 2, 2010

Related U.S. Application Data
(63) Continuation-in-part of application No. 12/253,503, filed on Oct. 17, 2008.
(60) Provisional application No. 61/222,854, filed on Jul. 2, 2009.
(60) Provisional application No. 60/981,416, filed on Oct. 19, 2007.

(51) Int. Cl. G06F 17/30

(52) U.S. Cl. 707/740; 707/E17.09

(57) ABSTRACT

An electronic commerce system for categorizing products and services using item types in order for the products and services to be posted to online marketplaces or advertising websites. The item types are associated with a plurality of categories from a number of online marketplaces and online advertising websites. Each item type can be general or specific and have propeny/value pairs, the property/value pairs either being required or optional. Each specific item type is associated with a generic item type, wherein all specific item types are associated with the generic item type include property/value pairs of the generic item type.

### CROSS-REFERENCES TO RELATED APPLICATIONS

This patent application claims the benefit of United States Provisional Patent Application Ser. No. 61/222,842, filed Jul. 2, 2009, and is a continuation-in-part of U.S. patent application Ser. No. 12/253,503, tiled Oct. 17, 2008, which claims the benefit of U.S. Provisional Application Ser. No. 60/681,416, filed Oct. 19, 2007, all of which are hereby incorporated in their entirety by this reference, including any appendices, screen shots, and references therein.

### BACKGROUND OF THE INVENTION

### FIELD OF THE INVENTION

This invention relates to online marketplaces or advertising websites, and, more particularly, to an electronic commerce system for categorizing products and services using item types in order for the products and services to be posted to the online marketplaces or advertising websites, each item type having property/value pairs with an associated name and having a hierarchical placement.

Today, more and more people are selling and purchasing goods and services electronically, such as over the Internet. Each good or service can typically be listed under a category, with some capable of being listed under many categories. As the complexity of these categories increases, so do the number of headings that they fit under.

eBay, a well known online auction and shopping website, allows people and businesses to buy and sell a broad variety of goods and services worldwide. A majority of the sales take place through a set-time auction format, but subsequent methods include a substantial segment of listings in the “Buy It Now” category. When listing a product or service on eBay, the user can specify categories that the product or service is associated with. The categories can be general and/or specific, the general categories describing a broader concept than the specific categories. General categories for eBay can include antiques, books, cell phones, DVDs, jewelry, music, tickets, and video games, while specific categories can contain rugs, barware, monitors, bear making supplies, and pet supplies.

In addition to eBay, other websites allow a user to sell or post a service or product using the Internet, such as craigslist and StubHub. The categories provided by these websites allow for a user to not only easily locate a service or product, but also contribute to a more efficient system.

### SUMMARY OF THE INVENTION

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a system for categorizing information about an item for use by an online marketplace or online advertising website is presented. The system includes at least one processor and a database for storing item types associated with a plurality of categories from a number of online marketplaces and online advertising websites. Each item type is general or specific and has property/value pairs, with the property/value pairs being either required or optional. In addition, the system includes a memory operatively coupled to the processor. The memory stores program instructions, that when executed by the processor, causes the processor to perform routines.

These routines can include receiving categorical information from the online marketplaces and online advertising websites and generating item types by using the received categorical information and storing them in the database, the item types separated into a two-tier structure with generic item types at the first tier and specific item types at the second tier.

For any new listing, the routines determine whether there are any required properties for the item type and, if so, request and receive a value associated with a property for each required property/value pair. In addition, the routines request for and receive values associated with properties for optional property/value pairs. Furthermore, the routines generate a specific item type to send to the onlineto marketplaces and online advertising websites using the required and optional property/value pairs for each new listing and associate the specific item type to a generic item type.

In accordance with another aspect of the present application, a computer-implemented method for categorizing an item is presented. The method includes establishing generic item types. In addition, the method includes establishing specific item types associated with a generic item type. All specific item types associated with the generic item type include characteristics of the generic item type. The characteristics are based on categories from online marketplaces and online advertising websites. Specific values associated with the characteristics are unique to each specific item type.

In accordance with still yet another aspect of the present application, a computer readable medium storing instructions for causing at least one processor to perform a method that generates item types for posting to an online server is presented. The method includes receiving a category tree from the online server, the category tree describing general and specific categories in which items can be classified. In addition, the method includes establishing item types based on the general and specific categories described by the category tree, wherein the item types can be either generic item types or specific item types, the specific item types having required fields. Furthermore, for each required field within a specific item type, the method includes requesting and receiving values for the required field.

### BRIEF DESCRIPTION OF ATTACHMENTS

ATTACHMENT A (2 Pages) titled “Item types” discloses useful information on how items or products can be placed within item types and how the item types are distinguished from one another. ATTACHMENT A is hereby incorporated by reference in its entirety, including, any appendices, screen shots, and references thereto.

ATTACHMENT B (1 Page) titled “Spread Sheet of Item Types” discloses generic and specific item types for use within the system and method described herein. ATTACHMENT B also shows categories that are required by certain online marketplaces such as eBay. ATTACHMENT B is hereby incorporated by reference in its entirety, including, any appendices, screen shots, and references thereto.

ATTACHMENT C (7 Page) titled “eBay Categories” discloses eBay categories which users can place their items. As shown, the larger bolded words represent generic categories while the smaller words are directed towards more specific categories. ATTACHMENT C is hereby incorporated by reference in its entirety, including, any appendices, screen shots, and references thereto.

ATTACHMENT D (1 Page) titled “Craigslist” discloses categories which craigslist users can place their items or services. ATTACHMENT D is hereby incorporated by reference in its entirety, including, any appendices, screen shots, and references thereto.

ATTACHMENT E (2 Pages) titled “StubHub” discloses categories which StubHub users can place their tickets. ATTACHMENT E is hereby incorporated by reference in its entirety, including, any appendices, screen shots, and references thereto.

ATTACHMENT F (4 Pages) titled “Hierarchical Item Identification System Examples” discloses illustrations of how specific and generic item types relate to one another. ATTACHMENT F is hereby incorporated by reference in its entirety, including, any appendices, screen shots, and references thereto.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1A is a block diagram showing an exemplary architecture depicting elements contained within an illustrative remote wireless device in accordance with one aspect of the present application;

FIG. 1B is a block diagram showing an exemplary architecture for interaction between the remote wireless device, the service system and the sales listing system in accordance with one aspect of the invention;

FIG. 2A is a block diagram depicting an illustrative registration process in accordance with one aspect of the present application;

FIG. 2B is a block diagram depicting an illustrative account creation and selection process in accordance with one aspect of the present application;

FIG. 3A is a block diagram depicting an illustrative listing process in accordance with one aspect of a first embodiment of the present application;

FIG. 3B is a block diagram depicting an illustrative service system server companion processes for listing items in accordance with one aspect of a first embodiment of the present application;

FIGS. 3C, 3D and 3E are block diagrams depicting an illustrative listing process in accordance with a second embodiment of the present application with interactive service system server companion processes;

FIG. 4 is a block diagram illustrating an exemplary post sale process in accordance with one aspect of the present application;

FIGS. 5A through 5I are exemplary implementations of the illustrative system on a PDA or cell phone for the listing process including data entry and imaging in accordance with one aspect of the present application;

FIGS. 6A through 6C are exemplary implementations of the illustrative system on a PDA or cell phone for account maintenance and review in accordance with one aspect of the present application;

FIGS. 7A and 7B are exemplary implementations of the illustrative system of the PDA or cell phone for post sale shipment and other general functions in accordance with one aspect of the present application;

FIG. 8 is a block diagram representing a typical computer system to interact with other devices or networks associated with the computer in accordance with one aspect of the present application;

FIG. 9 is a functional block diagram generally illustrating an exemplary client computer interacting with online marketplace servers to receive categories from the marketplace in accordance with one aspect of the present application;

FIG. 10 depicts illustrative item types in accordance with one aspect of the present application; and

FIG. 11 is an exemplary flow chart for generating categorical-based item types in accordance with one aspect of the present application.

### DESCRIPTION OF THE PREFERRED EMBODIMENT(S)

The description set forth below in connection with the appended drawings is intended as a description of presently-preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

System Overview

Generally described, this provisional application relates to online marketplaces or advertising websites, and, more particularly, to an electronic commerce system for categorizing products and services using item types in order for the products and services to be posted to the online marketplaces or advertising websites, each item type having property/value pairs with an associated name and having a hierarchical placement. In one illustrative embodiment, the item types are associated with a plurality of categories from a number of online marketplaces and online advertising websites. Each item type can be general or specific and have property/value pairs, the property/value pairs either being required or optional. Each specific item type is associated with a generic item type, wherein all specific item types associated with the generic item type include property/value pairs of the generic item type.

In another illustrative embodiment, item types are generated from received categorical information. The item types are separated into a two-tier structure with generic item types at the first tier and specific item types at the second tier. For new listings by a user, values for required property/value pairs are filled into a specific item types. In addition, values are also filled into optional property/value pairs. The specific item types are then sent to an online marketplace and/or online advertising website using the required and optional property/value pairs for each new listing.

In still yet another embodiment, the item types are not limited to a two-tiered structure. Instead, the depth of the item types are determined by three factors. These factors include the prevalence of user searches, the benefit to the user experience, and the enrichment of data, all of which will be described in more detail below.

In essence, the item types described above and presented herein determine what type of information is required from a user to fill in before the item can be posted to the marketplace or advertising website, the information coming from category trees from the marketplace or advertising website. By establishing generic item types along with specific item types, characteristics shared between each can be establish, which provides an easier to use system and method for presenting information to the marketplace or advertising website.

Continuation-In-Part

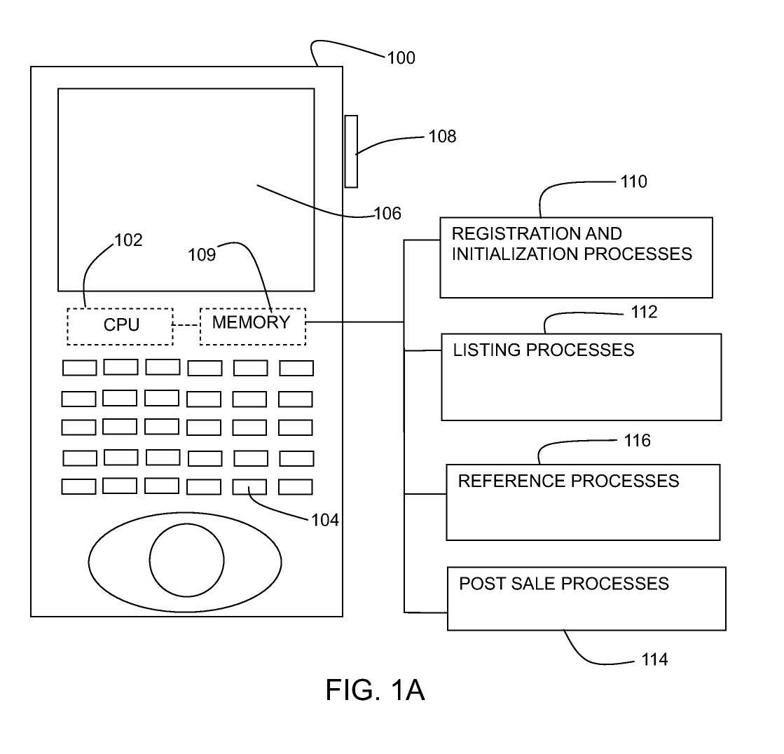

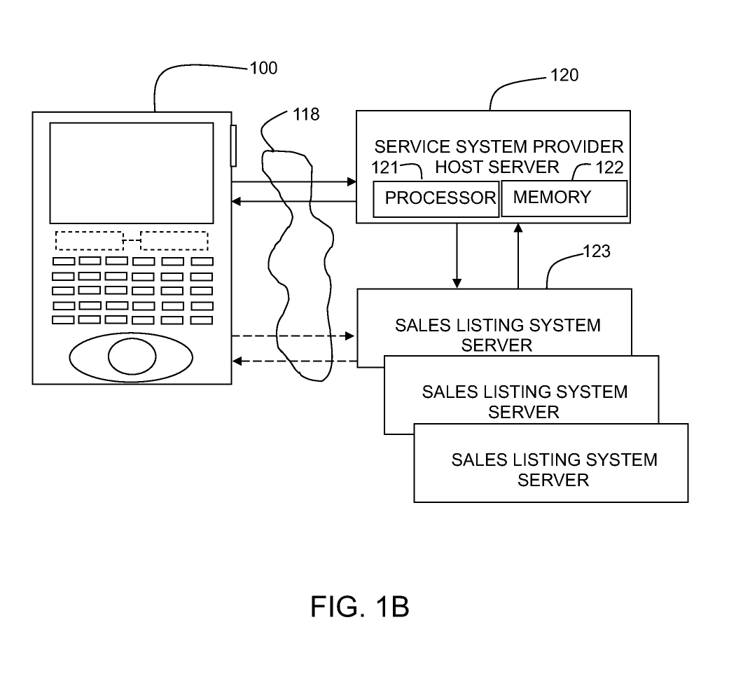

For purposes of clarity, the non-provisional application to which this provisional application claims priority to is hereinafter substantially repeated. The previous application incorporated a wireless device as shown in FIG. 1A such as a cellular phone or PDA 100 having an integral central processing unit (CPU) 102, an input keyboard 104, display 106 and an integrated camera 108. An operating memory interacts with the CPU and incorporates multiple processing modules including a Registration and Installation Process 110 for installing components of the system on the PDA 100, a Listing Process 112 for employing the PDA within the installed system and integrated camera for entering the sales details of an item and communication with the selling agency for transmission/verification of the sales details and a Post Sale Process 114 for transaction notification and completion. Embodiments of the application as implemented include additional functions for preference settings and reference processes 116 associated with the PDA operation for listing development and communication with the selling agency.

As shown in FIG. 1B, the PDA communicates over a network 118 with a provider host server 120 for a service system that provides downloads of the various modules to the PDA. The server incorporates processor 121 and a memory 122 or other storage capability. In certain embodiments, the provider host servers interface with servers 123 of a sales listing system for actual communication of listings. In alternative embodiments, the PDA communicates directly with the sales listing system servers for actual listing of the item for sale.

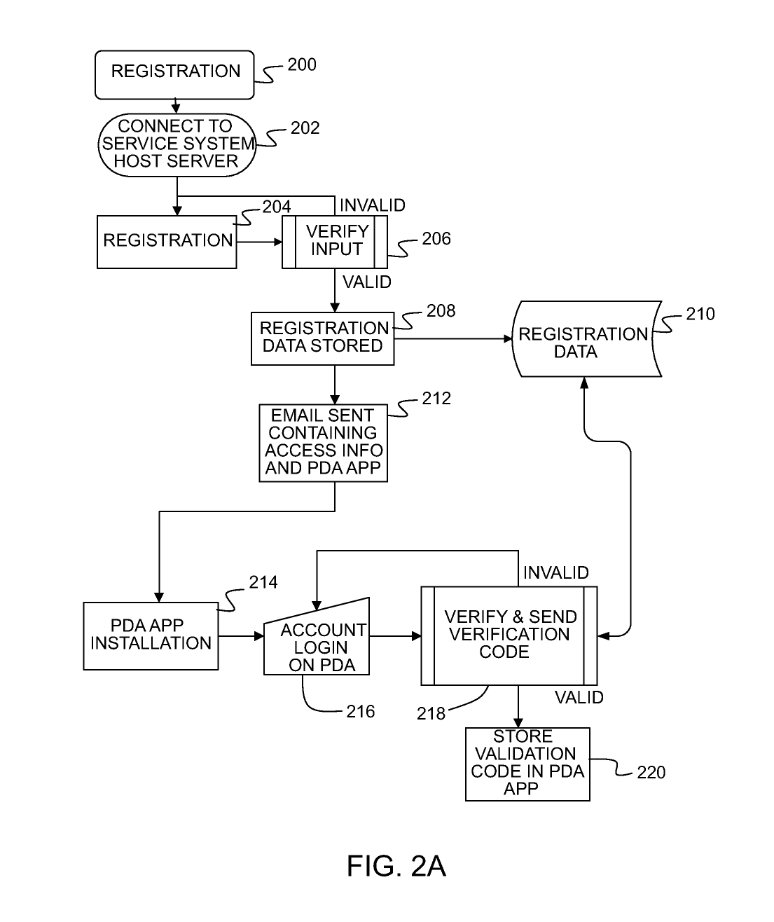

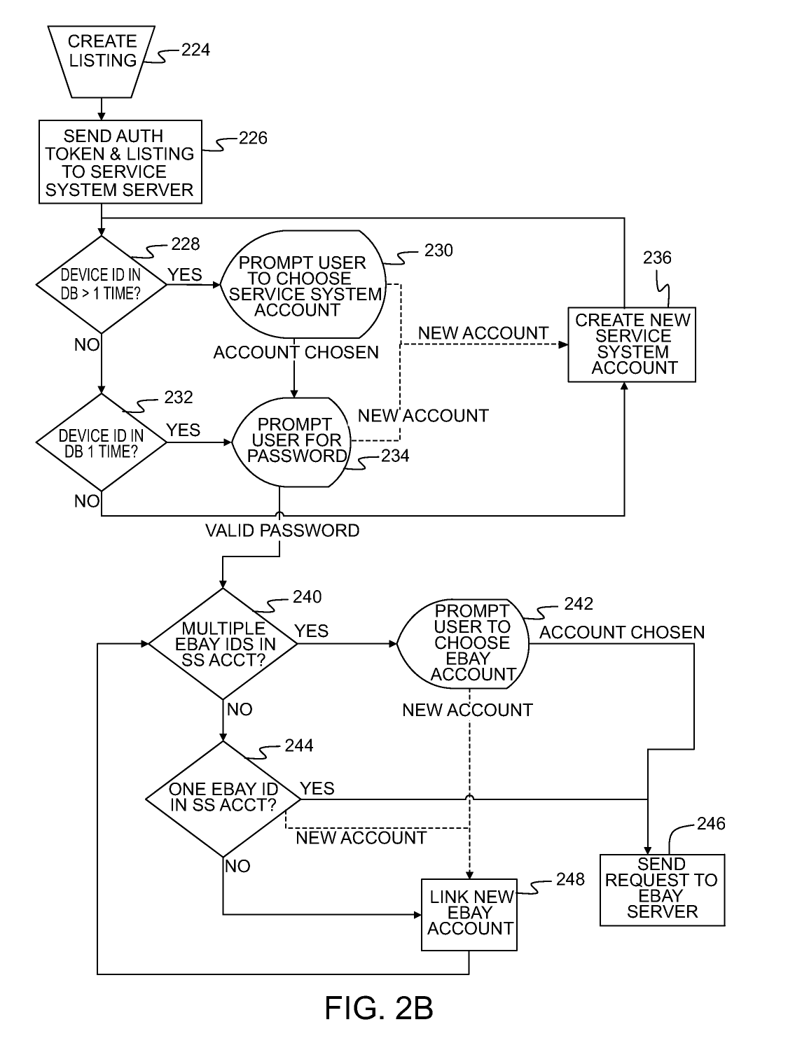

Referring to FIG. 2A, the Registration and Installation Process 110 includes downloading of interactive modules to the PDA 100 through a wireless web connection from a service system provider, entry of registration data for the user via the web connection to the service system servers and an activation process for installation of the interactive modules. The registration process begins at block 200. At block 202, a PDA 100, equipped for incorporating the modules described above, is wirelessly connected to a host server for the service system, and registration information is transmitted to the server at block 204 with the server verifying the input at block 206. If invalid input is received, an appropriate message is returned to the PDA and the system returns to block 204 for transmission of registration information. A valid input will result in storage of the PDA data at block 208 in a database 210 associated with the service system. An e-mail or similar type of communication is sent by the service system server at block 212 providing access information and the downloadable application software for the system modules. The downloaded application is installed on the PDA at block 214 and the PDA is then enabled for account login at block 216. Upon logging-in to the host, the host will verify the PDA data and application modules and if valid, will provide a validation code at block 218 to be stored in the PDA for future use at block 220. The registration and installation process is then complete. If an invalid input is received upon account login, the host will respond with an error message and return to block 222 for account login.

In addition to initial registration and downloading of the software system to the PDA, FIG. 2B demonstrates an exemplary process for registration of accounts in the system. Upon entering the system to create a listing at block 224, the PDA sends an authorization token and listing request to the server at block 226. The server determines if a device ID exists in the service system database (DB) at more than one location at decision block 228. If so, the user is prompted on the PDA display to choose the appropriate account relating to that device ID at block 230. If the device ID only exists once in the service system database at decision block 232 or upon selection of the desired account, the user is prompted on the PDA display to enter a password at block 234. If the device ID does not exist in the service system database, a new account is created at block 236 as previously described in blocks 218 through 222 of FIG. 2A. Upon entry of a valid password by the user, a determination is made if multiple account IDs for the selected listing service, such as eBay, Amazon, or Craigslist are present at decision block 240. If so, the system directs the PDA to display a prompt for the user to choose one of the accounts at block 242. If multiple account IDs do not exist for the listing service, a determination is made if one ID exists at decision block 244. If one ID exists or upon choice of the desired account by the user responsive to the prompt at block 242, the service system forwards the listing request to the listing server at block 246 (an E-bay server in the drawing example). If no listing service ID is present, a link is created to the listing service for creation of a new account at block 248. At the prompt for either block 242 or block 244 the user has an option of creating a new account.

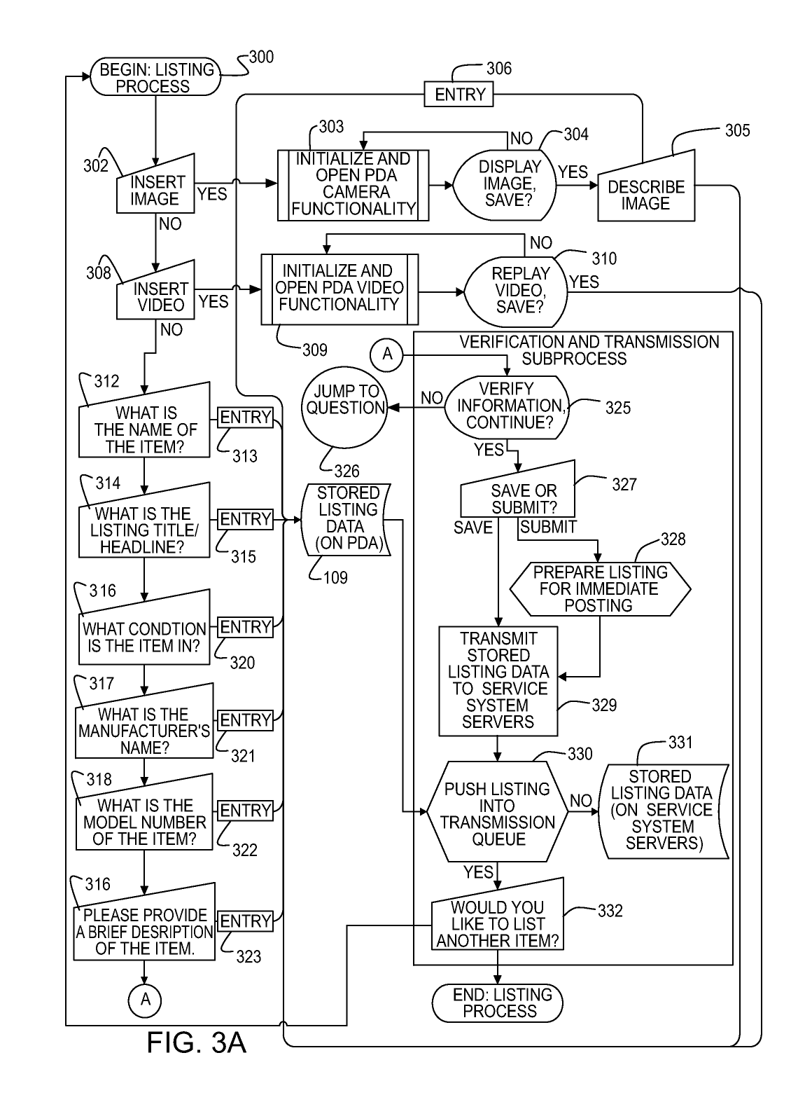

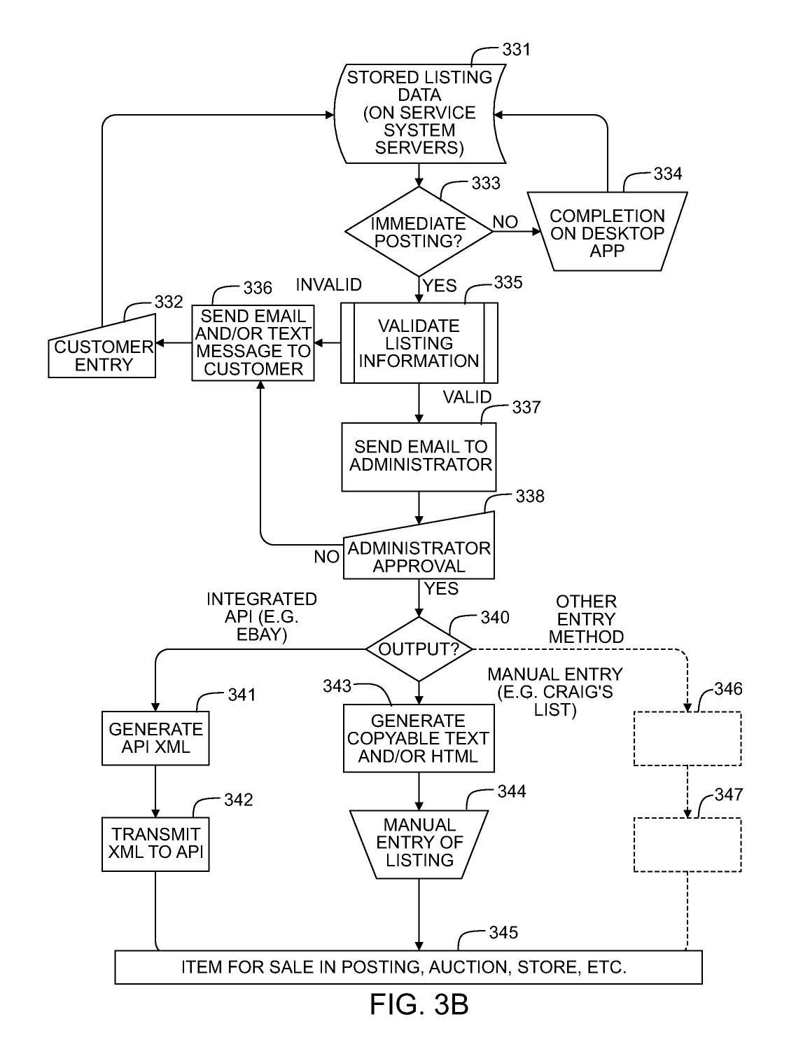

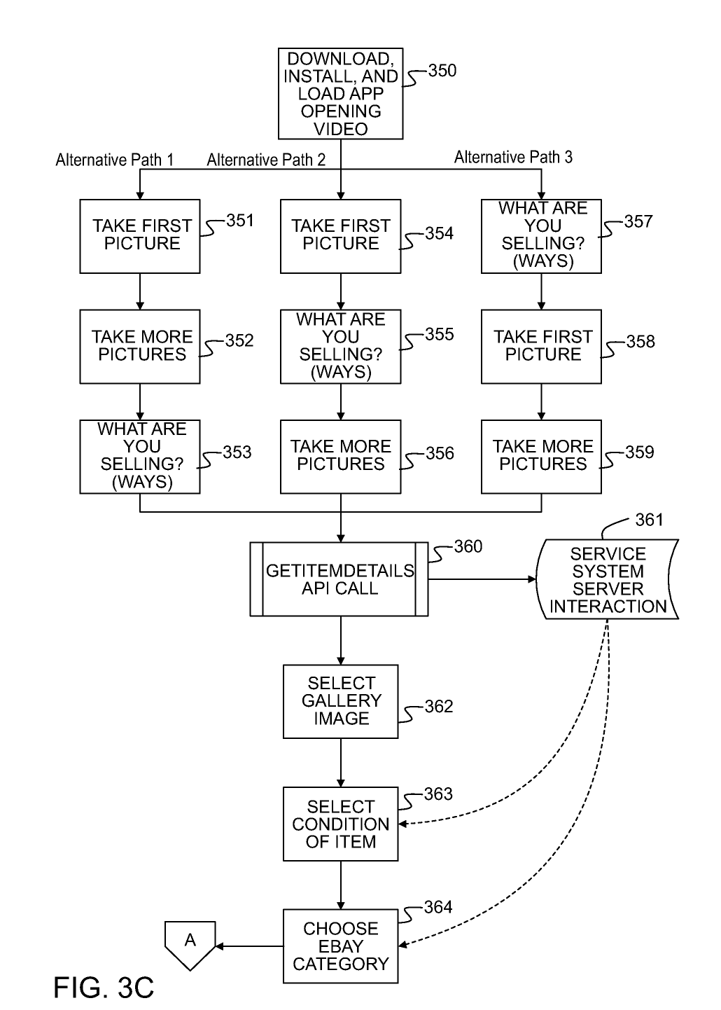

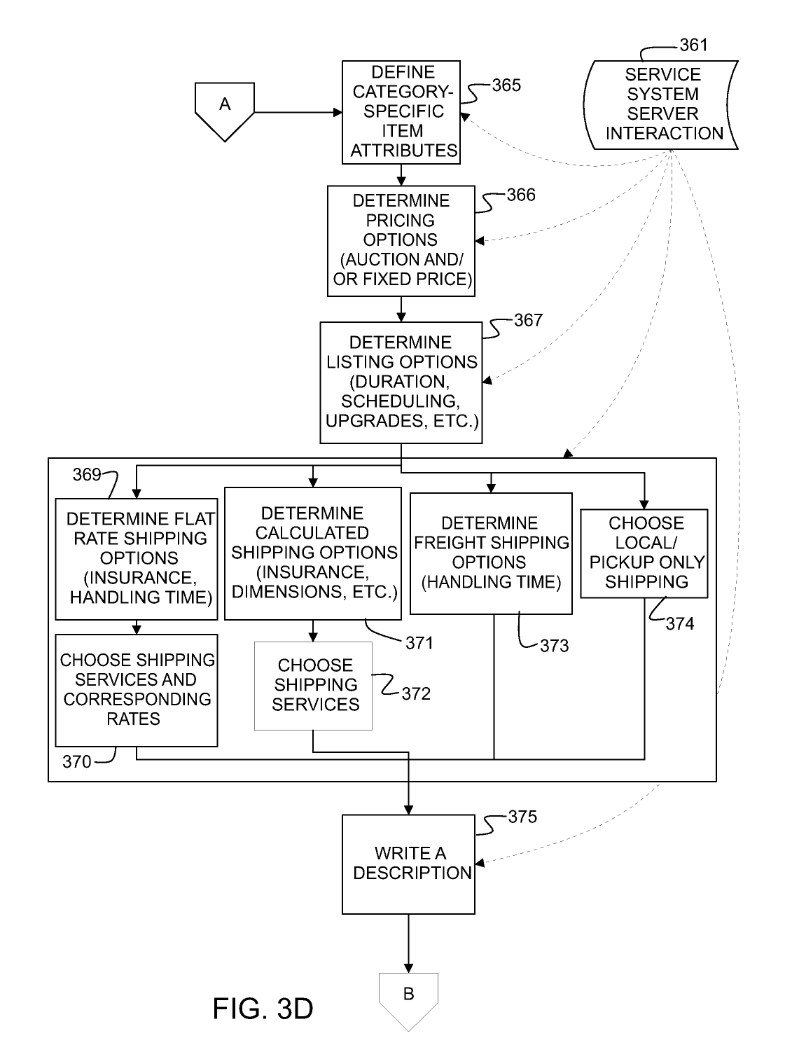

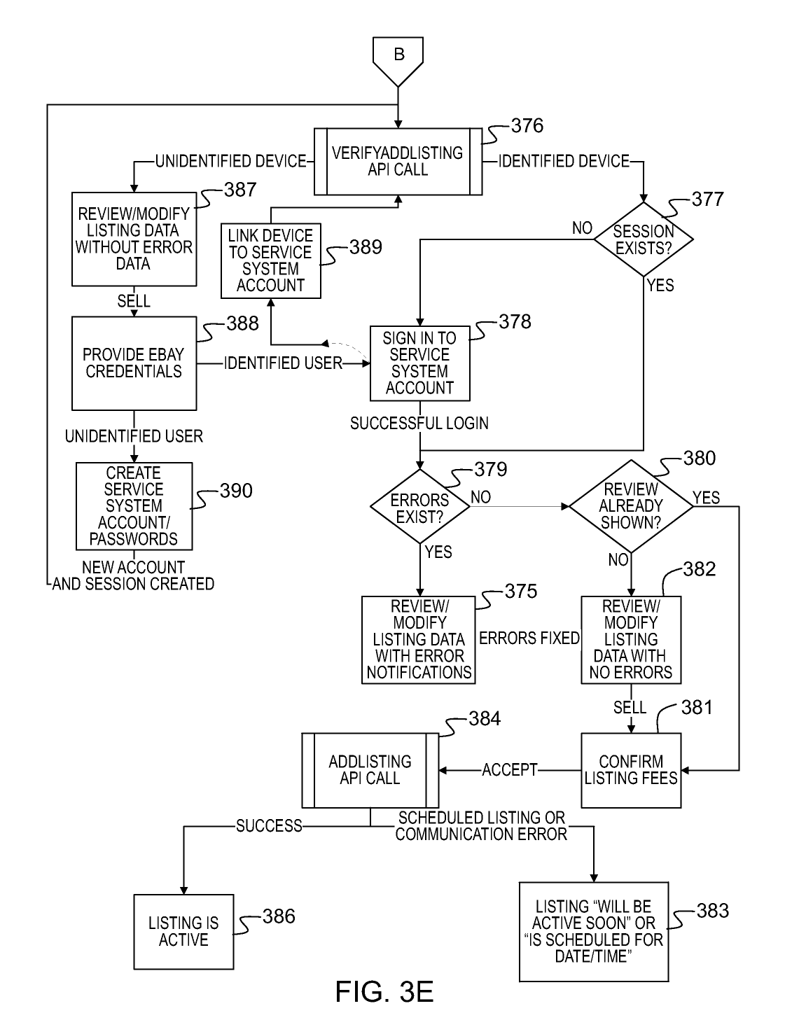

The Listing Process for a first embodiment, shown in detail in FIG. 3A, includes a plurality of routines prompted by the interactive modules on the PDA which can be accomplished prior to entry into the service system server for listing of a sale item to save time and minimize wireless connection time issues. Commencement of the listing process 300 on the PDA is prompted by a request for photo entry at. block 302. Using an integrated camera in the PDA or cell phone, the PDA initializes and opens the camera functionality at block 303. The image taken by the user is displayed and a prompt to save the image is provided at block 304. If the image is not sufficient or accepted by the user, the user can select not to save the image and the PDA reverts to the camera mode. If the user saves the image, a prompt is provided for a description of the image at block 305 which is then entered at block 306 on the PDA keypad and a return to the prompt for images is made. Each entry such as block 306 and those subsequently defined are stored on the PDA as listing data as will be described in detail below.

A prompt for video input is then made at block 308 and if selected, the PDA initializes and opens the PDA video functionality at block 309. Upon completion of video input, a prompt for viewing and saving the video is provided at block 310. If not saved, the system reverts to the video input prompt. If saved by entry 311, the data input for the item is stored in the PDA. Multiple items can be prepared for listing and stored on the PDA.

The system then prompts the user for an item name at block 312 which is entered at block 313 using the PDA keypad. A listing title or headline (which can be prompted in a specific format for predetermined sales service providers (i.e. E-bay)) is requested at block 314 and entered at block 315. The item condition at block 316, manufacturer at block 317, model number at block 318 and item description at block 319 are requested with PDA inputs by the user reflected at blocks 320, 321, 322 and 323. Each entry stores data in the memory 109 of the PDA.

A verification and transmission process module at block 324 is activated when the user elects to transmit data to the sales service provider which allows a data review and communicates with the provider (including selection of provider in certain embodiments). A verification routine at block 325 allows the user to scroll through the information input in the listing process and, if a data change is required, allows jumping at branch 326 to the entry question (blocks 312, 314, 316, 317, 318 and 319) for correction/entry. The user is then prompted to save the listing data to the host at the service provider or submit the listing at block 327. The data save to the host allows further processing by the user from a companion desktop application at a personal computer or other network device if more convenient. If a “submit listing” choice is made, the system prepares the listing for immediate posting at block 328. After the listing preparation or if storage on the service system server has been selected, a transmission module at block 329 is activated. The PDA accomplishes a log-in as previously described with respect to FIG. 2B and the PDA pushes the listing into a transmission queue at block 330 retrieving data from the PDA memory which has received each of the listing inputs. The data for the item is then stored on the service provider host server at block 331.

Companion modules on the service system server receive the item data, perform listing functions and actual listing of the item, and confirm communications to the PDA of the listing and sale monitoring/notification functions. As shown in FIG. 3B, the data stored from the PDA is available on the host server data storage at block 331. If the host determines that immediate posting was not selected by the user at block 333, the host module makes the data available for interaction with a PC or other network terminal available to the user for completion of the listing at block 334. If posting has been directed, the host validates the listing information at block 335, and if invalid, generates an e-mail and/or text message to the user at block 336, which is received by the PDA. User input from the PDA through the verification routine previously described provides revised data in the stored data listing for processing. A valid listing results in an e-mail or similar type of communication to the service system server administrator at block 337 for approval of the posting at block 338. If posting is not approved, the service system server reverts to block 336 sending an e-mail or similar type of notification to the user. If the posting is approved, an output will be made at block 340, and a service provider host with an integrated API will generate an appropriate XML for the API at block 341 and transmit the XML to the API for operation at block 342. Alternatively, the service provider administrator will generate copyable text and/or HTML at block 343 and provide manual entry of the listing at block 344. The item posted will then be shown in the service providers, posting, auction or store at block 345. Alternative listing service data entry protocols represented generically as blocks 346 and 347 can be accommodated.

An alternative embodiment for the listing process is shown in FIGS. 3C through 3E. The software download, installation and initiation at block 350 are accomplished as previously described. Upon opening the listing application on the PDA three optional paths are available to the user. In the first alternative path, a prompt is provided on the screen requesting the user to take a first picture. Upon entry of the image at block 351, a prompt is provided on the screen for additional pictures. If the user takes additional pictures, images are entered at block 352, and a prompt is provided on the screen for “what are you selling” (WAYS) with entry of an item title by the user at block 353. In the second alternative path entry of a first image, block 354 results in a prompt for WAYS with entry of an item title by the user, block 355. A prompt is then provided on the screen for additional pictures and additional images are entered at block 356. In the third alternative, the WAYS is prompted on the screen and entered by the user at block 357. A prompt for a first picture is then provided with entry of the image taken by the user at block 358. A prompt for additional pictures is provided on the screen and, if the user takes additional pictures, images are entered at block 359.

The PDA then establishes wireless contact with the service system provider host at block 360 to commence the listing interaction. The service system provides interactive analysis and processing of the various listing input parameters to provide automated assistance where applicable at block 361. A gallery of the images entered for the listing is then presented to the user and a selection of the desired image is made at block 362. A prompt is then provided to select the condition of the item and a condition entered or selected by the user is stored at block 363. A prompt is then provided to select a category for the listed item consistent with the listing service to be used and the chosen category is entered at block 364.

A prompt is then made to define category specific item attributes which are then entered as defined by the user at block 365. Based on the listing service to be used, a determination of pricing options, such as auction or fixed-price, is made at block 366, and listing options such as the duration of the auction, scheduling time for the auction and other listing service features are determined at block 367. For listing services where multiple shipping options are provided, screen prompts and data entry are accomplished, generally designated at block 368. For an exemplary listing service, a determination is made regarding flat rate shipping options such as insurance and handling time at block 369 and the shipping services and corresponding rates are then chosen at block 370. As a first alternative calculated shipping options are determined at block 371, and the appropriate shipping service is chosen at block 372. As a second alternative a determination is made regarding freight shipping options at block 373, and in the fourth alternative local pickup is selected at block 374.

A description is then written for the listed item at block 375, which incorporates the information entered in the interactive listing process on the PDA as set forth above. The description can be a compilation of the entries as entered or can be tailored by interactive operation with the service system's server. A review of the description by the user interactive alteration of the various inputs or recommendations can then be accomplished.

As a continuation of the listing process, or as a subsequent wireless contact, the PDA calls the service system provider host for verification of the ad listing at block 376. If upon the call the provider host recognizes the PDA as an identified device, a determination is made if a wireless session exists at block 377. If a session does not exist signing in to the service system account at block 378 is accomplished as previously described. Upon a successful log in or if a prior session did exist, a determination is made if errors in the listing are present at block 379. A determination is then made if a review of the listing by the user has been made on the PDA at block 380. If the listing has been reviewed by the user, a confirmation of listing fees to be charged by the sales listing service is made at block 381.

If the user has not yet reviewed the listing, data for the review is provided on the PDA screen at block 382, and if no errors are identified or changes made by the user as designated by a “sell” instruction, the listing fees are then confirmed. Similarly, if errors do exist in the listing as detected by the provider host, listing data for a review with error notifications is presented to the user at block 383. Entries by the user to fix the identified errors results in presentation of the listing data as previously defined for block 382.

Upon acceptance of the listing fees the provider host issues a listing call to the listing service server at block 384. A successful interaction between the provider host server and the listing service server results in an active listing at block 385. If the listing is subsequently to be scheduled or a communications error occurs between the service provider host and listing service server, notification is provided to the user on the PDA screen at block 386.

If the device is unidentified during the verify add listing call of block 376, a data review for the listing is presented at block 387, and upon a sell command from the user listing, service credentials are provided at block 388. An identified user is then signed into the service system account as previously defined in block 376 and the device is linked to the service system account at block 389. If the user remains unidentified, a service system account is created at block 390, and the new account and session are created.

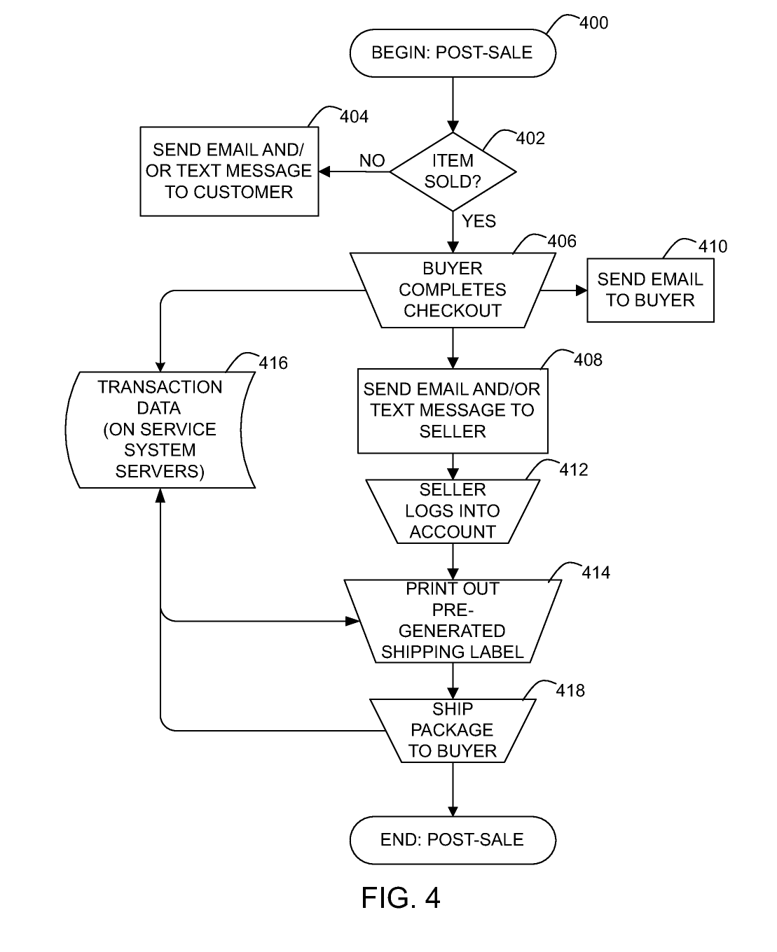

The Post Sale Process 400 shown in FIG. 4 employs the companion modules at the service provider host to monitor the posting for sale at block 402. If the item is not sold, the host sends a text message or email notification to the PDA notifying the user at block 404. If the item is sold, and the buyer completes the internal checkout processes of the provider at block 406, the host sends a text message or email notification to the PDA of the sale at block 408. Standard host processing for notification of the buyer through e-mail is also accomplished at block 410 and the transaction data for delivery is stored at the host at block 412. Upon receipt of the “sale” message, the PDA system then provides automated interactive modules to the user to log into the account at block 412 for shipping instructions and printing out a pre-generated shipping label at block 414 through interaction with the transaction data at block 416 saved on the host data storage system. Upon shipment of the package to the buyer, the PDA system is used to transmit a shipment notice at block 418 to the host for storage on the host data system and post sale requirements.

A system employing the previous application is compatible with advanced PDAs and cellular phones which preferably provide, as described previously with respect to FIG. 1A, a touch sensitive screen 106 and standard cursor controls 107 for manipulating data on the screen. A keypad 104 for data entry provides input for the various text elements required by the system. In alternative embodiments, use of stylus written input using systems such as Palm® Graffiti or a keyboard image on the screen and with touch activation can be employed.

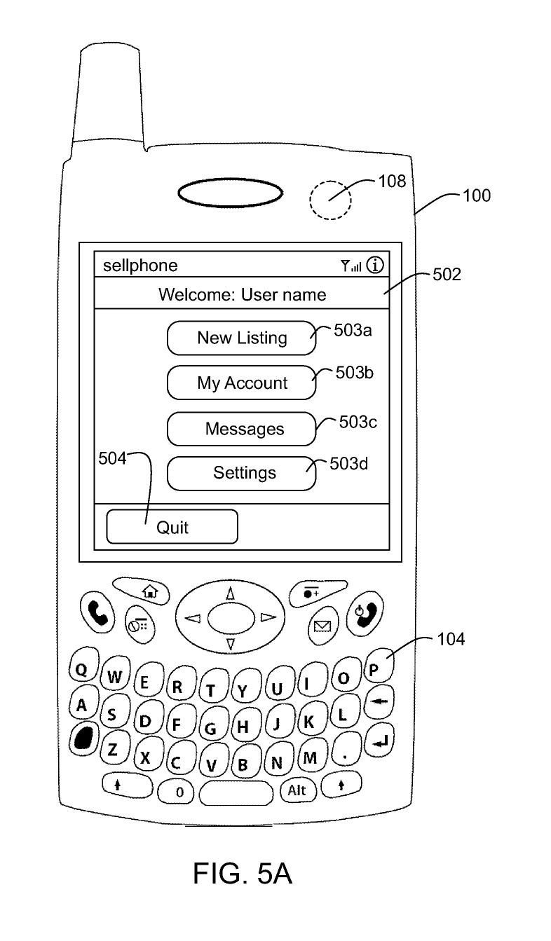

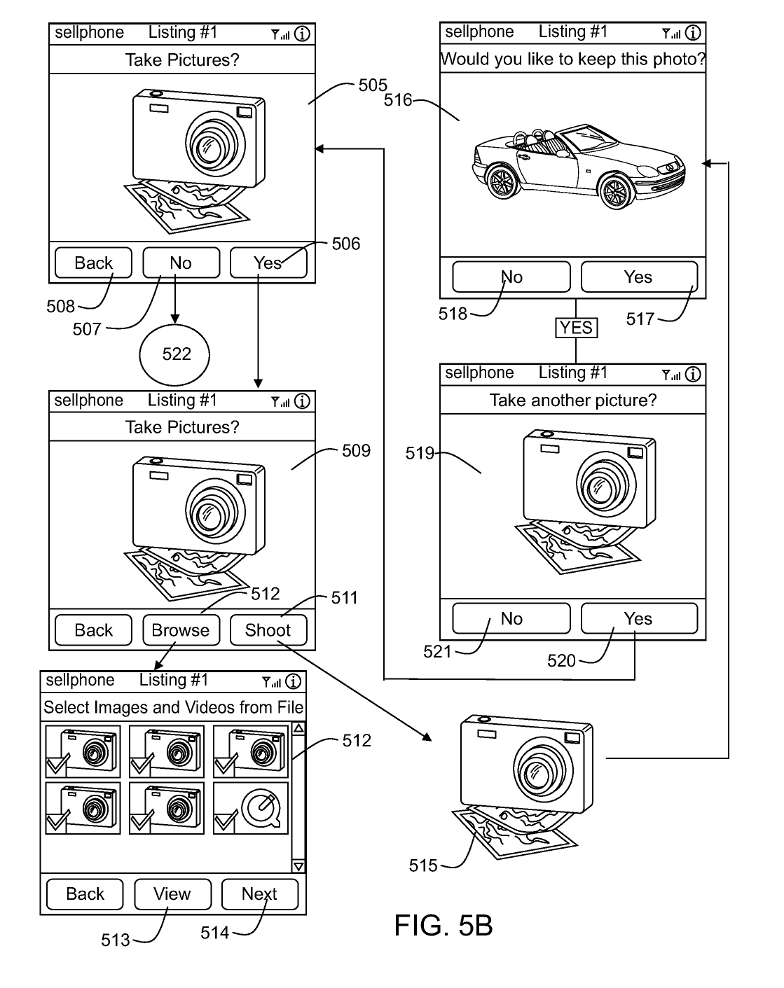

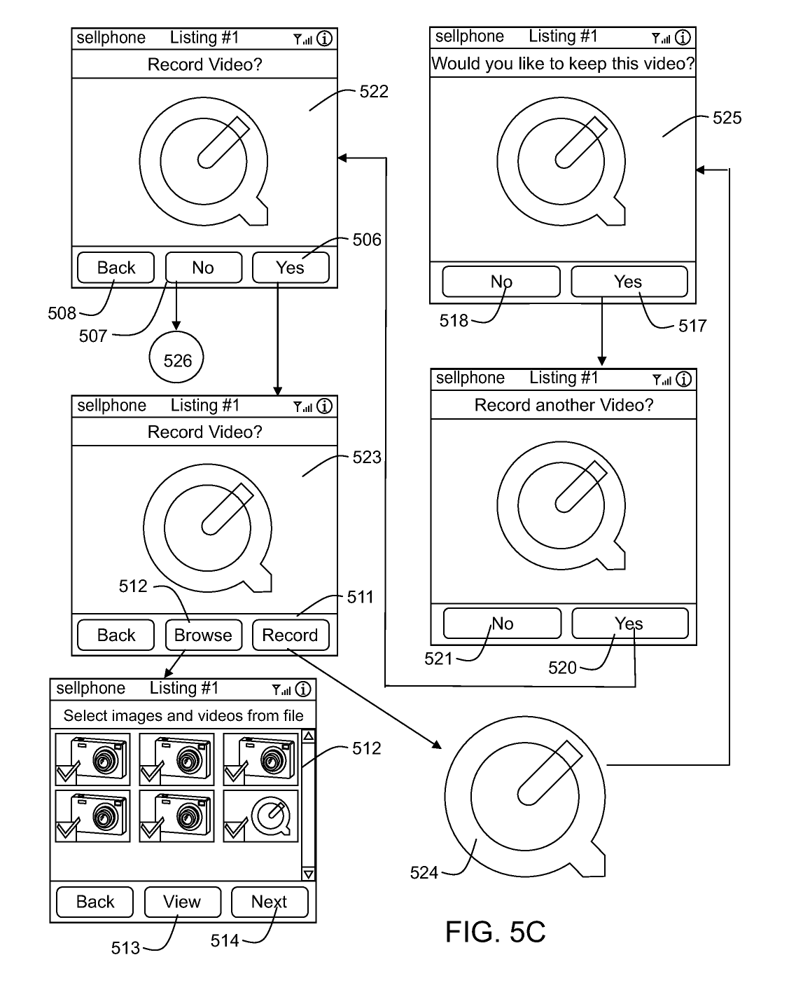

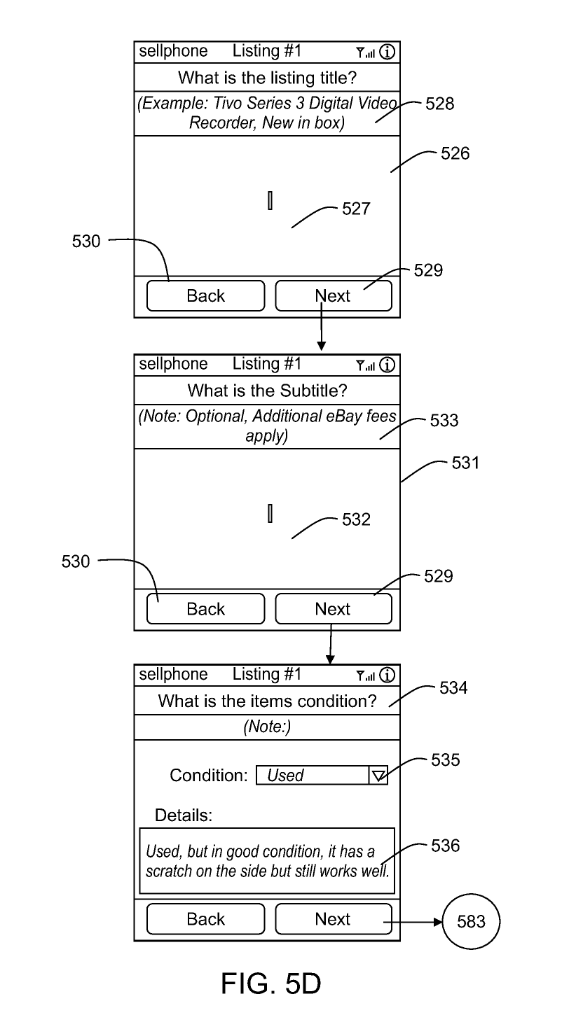

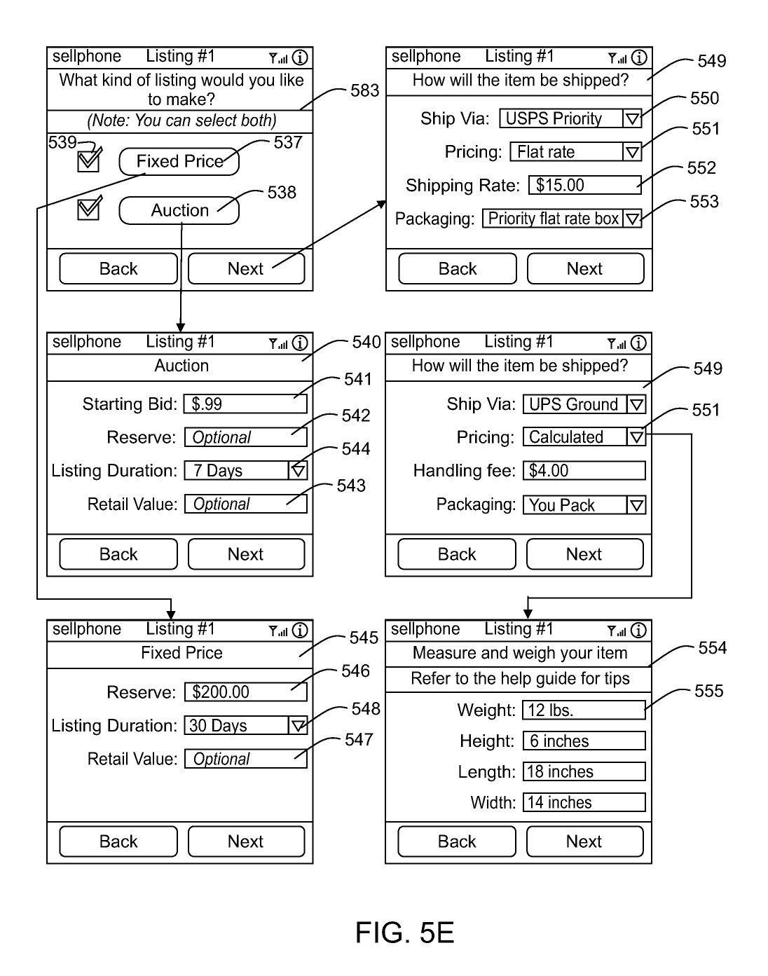

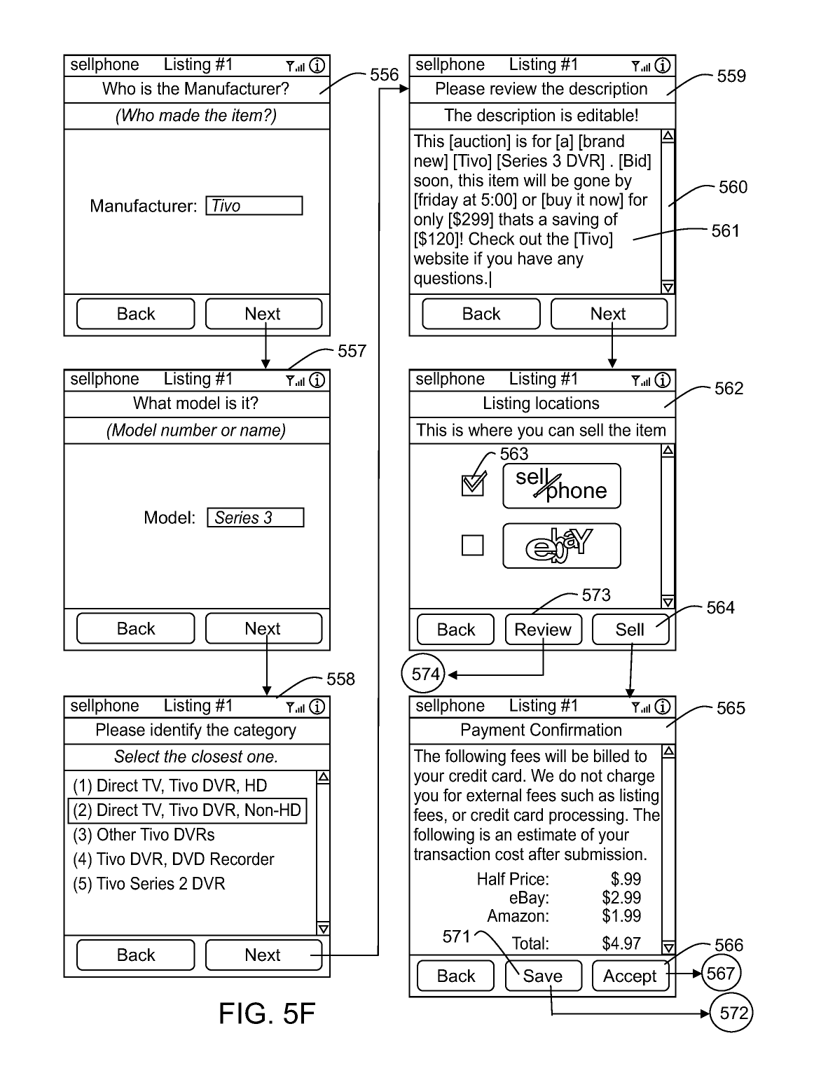

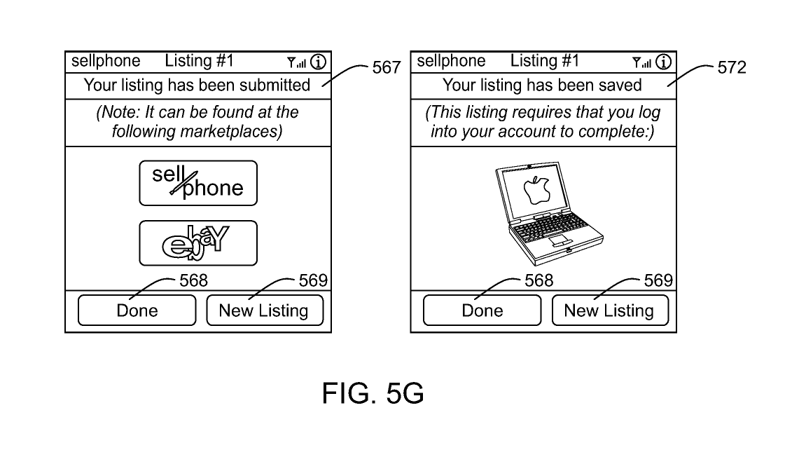

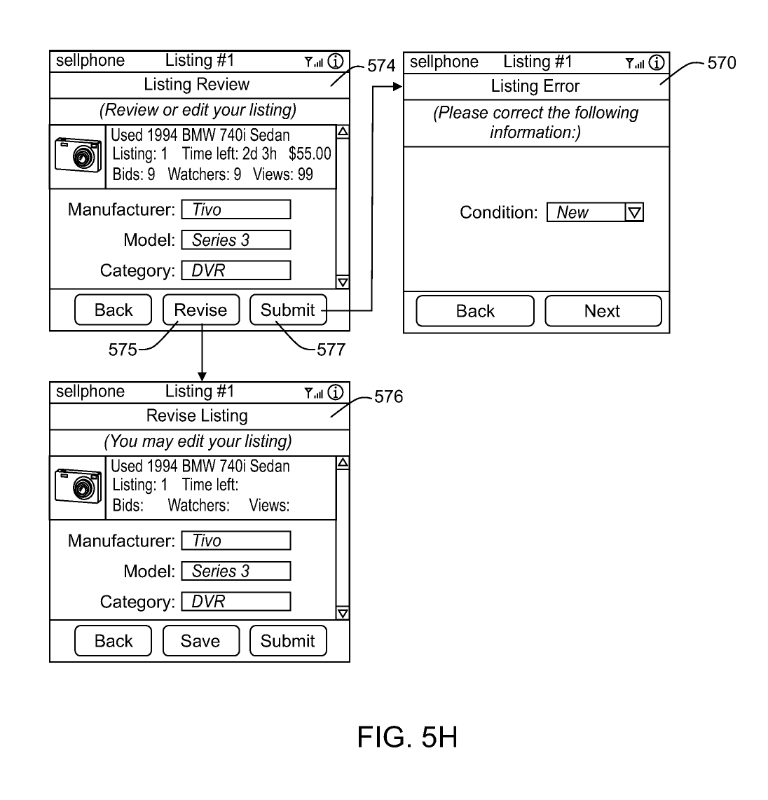

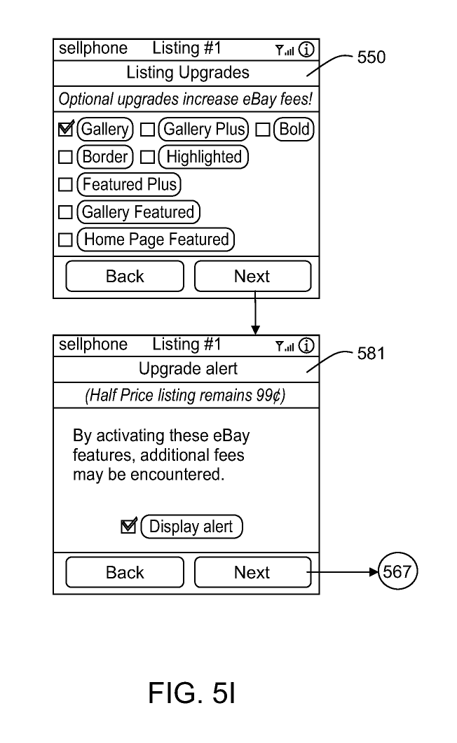

An exemplary embodiment of the inventive system, employed on an advanced PDA/Cellular Phone such as a Palm® Tree™ Smart Phone with touch screen capability activated by contact of the user's finger or a stylus (referred to herein as “touching”), is shown with interactive screen shots for the PDA using processes described in FIGS. 5A through 5I, 6A through 6C and 7A through 7D. Referring to FIGS. 5A through 5I, the system display for the exemplary embodiment provides a welcome screen 502 when initialized. The initial screen includes multiple interactive buttons for selection of available functions such as new listing 503a, my account 503b, messages 503c, and settings 503d. A quit button 504 allows for exiting the program. Touching the new listing button brings up a photo entry screen 505 as shown in FIG. 5B. The screen provides buttons for function selections: a yes button 506 to engage the camera function or a no button 507 to advance to the next screen. A back button 508 is provided to return to the listing text element screens. If the yes button is touched, a photo selection screen 509 is presented providing the option to select a photo from memory with a browse button 510 or capture a new image with a shoot button 511. Touching browse brings up an image memory screen 512 displaying icons for photos and video available in memory on the PDA. A view button 513 allows a selected image/video to be viewed and a next button 514 allows the image to be entered as the selected photo for the listing.

Alternatively, if a new photograph is desired, touching the shoot button on the photo entry screen initializes the internal camera function of the PDA allowing normal image capture represented by icon 515. The image is then displayed in a photo confirmation screen 516 which prompts the user to accept the image with a yes button 517 or reject it with a no button 518. A no selection deletes the image. A yes selection stores the image and brings up an additional photo selection screen 519 which provides a yes button 520 and a no button 521. A yes selection returns to the image capture sequence. A selection of the no button enters the image or images taken into the listing and advances to a record video option screen 522 providing a selection sequence for video comparable to the photo selection having video selection screen 523 with access to the image memory through screen 512 or activation of the internal video capture capability of the PDA 524, video confirmation 525 is provided having similar functionality to the image screen 516 as previously described. Upon completion of the image entry routines, a listing title screen 526 is presented which prompts the user to enter a title for the listing in a text entry block 527. For the embodiment shown an example block 528 provides additional assistance to the user. Next 529 and back 530 buttons are provided to advance after entry of the title or return to the welcome screen.

Touching next after entering the title brings up a subtitle screen 531 for optional entry of a subtitle in text entry block 532. As with the title entry screen, an example prompt 533 is provided which also can include information on system requirements or interaction such as the requirement for additional fees to enter a subtitle in the sales provider's system. Next 529 and back 530 buttons are again displayed for exiting the screen. Touching next brings up a condition screen 534 for entry of information on condition of the sale item. For the embodiment shown, a drop down box 535 with predetermined condition definitions is provided as well as a text entry box 536 for detail description. The condition entry screen is exemplary of the data input screens available for the system which are tailored for interface between the service provider system and the PDA. As will be described below, the PDA can initially prompt for a service provider definition prior to commencing the new listing process which will select and sequence the input screens based on the data available or required for listings on that service provider's system.

Upon completion of the text entry elements of the listing, touching next brings up a sales type option screen 583. Consistent with most current sales service provider systems, a fixed price button 537 and an auction button 538 are provided. For the embodiment shown, a check box 539 is associated with each sale type for selection. Touching the auction button launches an auction screen 540 providing text entry blocks for starting bid 541; reserve 542 and retail value 543 with a drop down box 544 with preselected auction periods. Similarly, pressing the fixed price button launches a fixed price sale screen 545 with text entry blocks for “Buy It Now” pricing 546 and retail value 547 and a drop down box 548 with preselected sales periods.

Completing or skipping the sales type screens, a shipment selection screen 549 is launched providing drop down boxes for shipment carrier 550 and pricing 551, which for the embodiment shown allows either fixed rate or calculated. A fixed rate selection allows entry of a shipping rate in text box 552. A packaging type drop down selection 553 is also provided. A selection of “calculated” in the drop box as shown in shipment selection screen 549 brings up a screen 554 for entry of shipping data such as weight and dimensions in text entry boxes 555.

Continuing with FIG. 5F, additional item information screens such as manufacturer screen 556 and model number screen 557 provide text boxes for entry of data. For commonly offered manufacturers, the system will provide preloaded data which is presented in additional screens such as the category selection screen 558 for selection by the user to supplement entered data. A final listing description is displayed in a review screen 559 with scroll bars 560 allowing the user to verify data as entered and as will be presented to the sales system provider for uploading and presentation to their customers. For the embodiment shown, elements of the description that have been entered are shown in highlighted text 561 and touching the highlighted text will return the user to the entry screen for that element to allow revision or correction.

Data for the created listing is now complete in the PDA based system. A listing location screen 562 is then presented to the user identifying the various sales service providers with which the PDA has been registered as previously described. Selection boxes 563 allow one or more listing services to be employed. A sell button 564 is provided for connection with the selected sales service provider. Upon connection and transmission of the listing to the provider, a payment confirmation screen 565 is presented with option buttons. In the exemplary embodiment shown, the confirmation screen provides cost information for the listing. An accept button 566 allows the user to accept the costs and enter the listing on the service. If the listing is error free, a submission success screen 567 is presented. On the exemplary screen, the user can then select a done button 568 to exit the system or a new listing button 569 for selection of an additional listing for entry from titles of saved entries.

If an error is identified in an attempted submission, a listing error identification screen 570 is presented identifying to the user that an error exists and requiring correction through logging on to the sales service provider's system via an internet terminal. This screen then gives the user option buttons for done or a new listing selection.

As an alternative to accepting the entry of the listing on the service, a save button 571 on the payment confirmation screen allows the user to store the listing data with the sales service provider for future access. If this option is selected, a data saved confirmation screen 572 is presented which again provides done or new listing selection buttons.

At the listing location screen 562 a review button 573 is also provided to allow the user additional options prior to entry of the listing with a sales service provider. If a single service provider has been selected, selection of the review button prompts a listing review screen 574 allowing the user to review all elements of the listing. A revise button 575 allows the user to access the various data entry screens through a revise listing screen 576. A submit button 577 is selectable to create an automated review of the listing. If successful, the listing locations screen is presented again. If an error is detected, a listing error screen 570 is presented which identifies the error and allows correction. Upon correction, the listing location screen is again presented to allow a sell button selection. A save button 571 is provided to allow the listing to be saved in the PDA memory.

At the listing location screen 562, if multiple sales service providers are selected as represented in the listing location screen as shown, options for the service providers are presented responsive to a next button selection in listing upgrade screens 580 providing various entry options. For the embodiment shown, warning screens 581 are presented if selection of entry options results in additional cost. Selection of the desired options and selection of a next button and/or acknowledgement of the warning screens by selection the next button results in submission of the listing to the service provider with presentation of the payment confirmation screen.

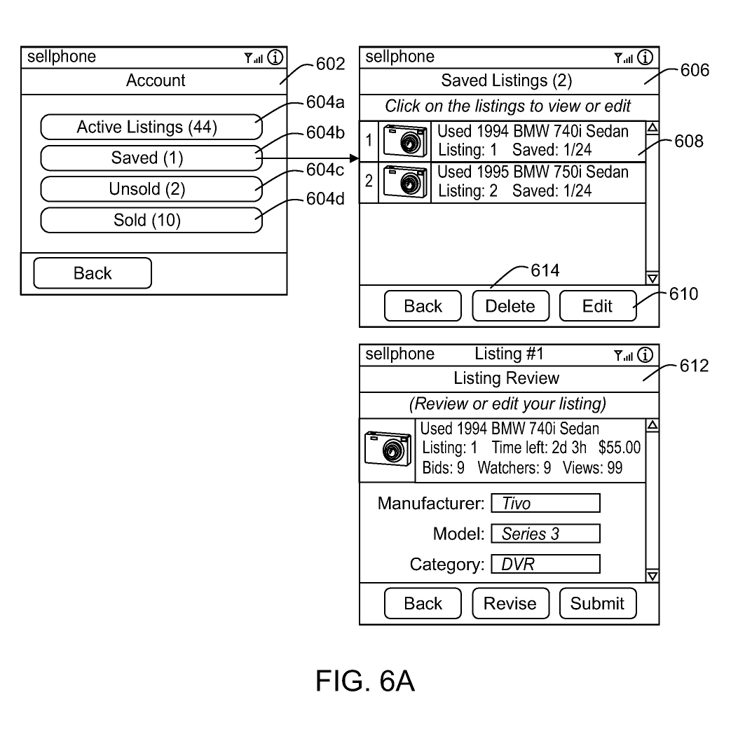

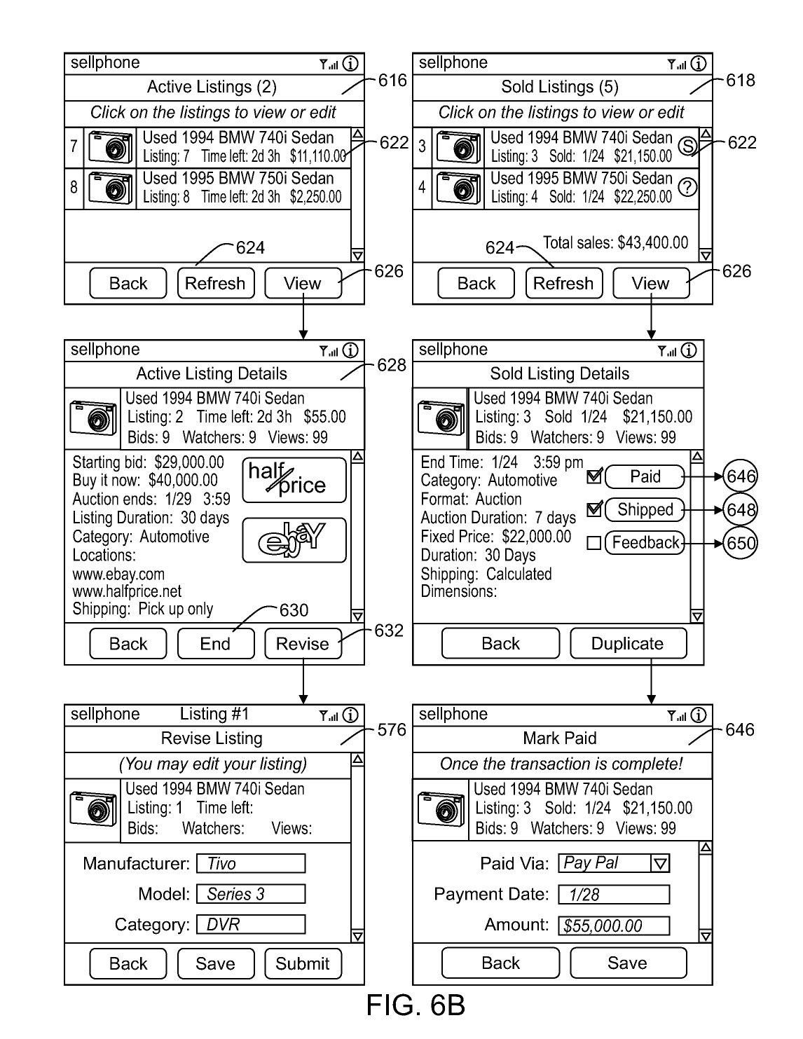

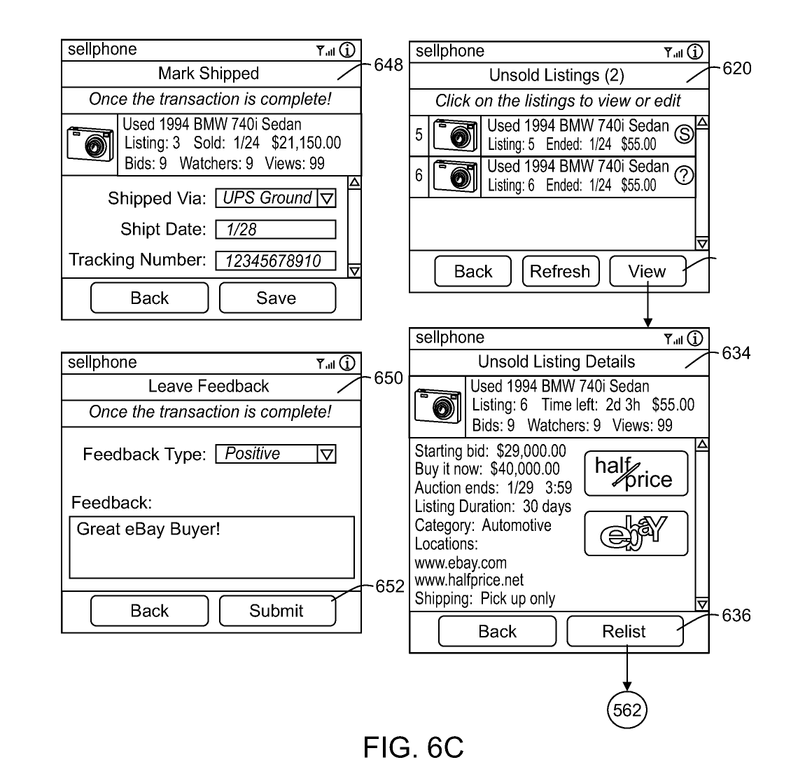

As previously identified with respect to the welcome screen 502 presented to the user upon initializing the system on the PDA, additional capability is provided as shown in FIGS. 6A through 6C for account maintenance upon touching of the my account button 504b. An account screen 602 is presented with option buttons for review of saved listings 604a, active listings 604b, unsold listing 604c, and sold listing 604d.

Selection of the saved listings button launches a saved listing screen 606 which provides identifiers 608 for each listing save in the PDA memory. An “edit” button 610 is provided for selection by the user to produce a listing review screen 612 of a selected listing with the features previously described to revise or submit the listing. Alternatively, a delete button 614 is provided to allow deletion of a selected entry.

The active listing, unsold, and sold selection buttons for the account screen provide information on listings previously submitted and prompt information and response screens based on interactions typically required with the sales service providers. Touching the respective buttons results in presentation of an active listing screen 616, a sold listings screen 618 or an unsold listings screen 620 respectively. Each of these screens provides identifiers 622 for each listing in that category, a refresh button 624 for connection to the service provider to update the status of the listings and a view button 626 to view the listing for a selected identifier.

For the active listings, responsive to the view button for a selected identifier, a details screen 628 is presented with all elements of the listing and the transaction status with the sales service provider's system. An end button 630 is provided to terminate the listing. A revise button 632 is provided to launch a revise listing screen 576 with functionality as previously described.

For unsold listings, responsive to the view button for a selected identifier, an unsold listing details screen 634 is presented showing the details of the listing and providing a relist button 636 which when touched transitions that listing to the listing locations screen 562 for reprocessing.

Finally, for sold listings, responsive to the view button for a selected identifier, a sold listing details screen 638 is launched which details the listing and provides buttons for designating paid 640, shipped 642 and feedback 644. Each of these buttons launches one of three respective screens; mark paid 646, mark shipped 648, and leave feedback 650 which allow entry of details regarding that function as text and/or drop down boxes. The leave feedback screen, in turn, has a submit button 652 allowing text feed back entered on the screen to be submitted to the buyer through the sales service provider system.

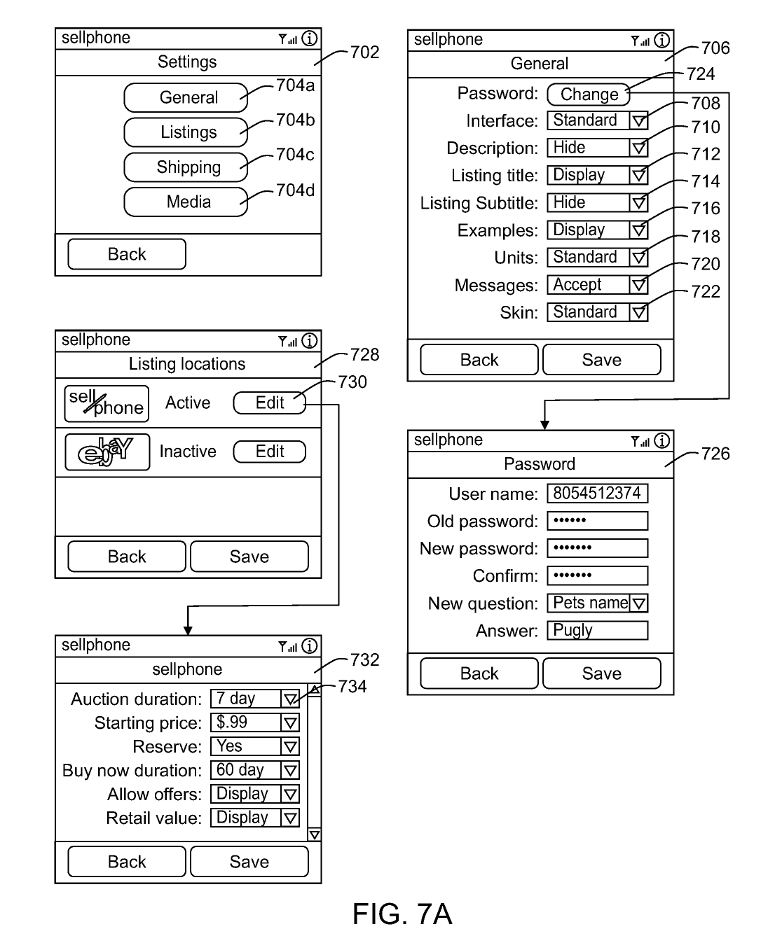

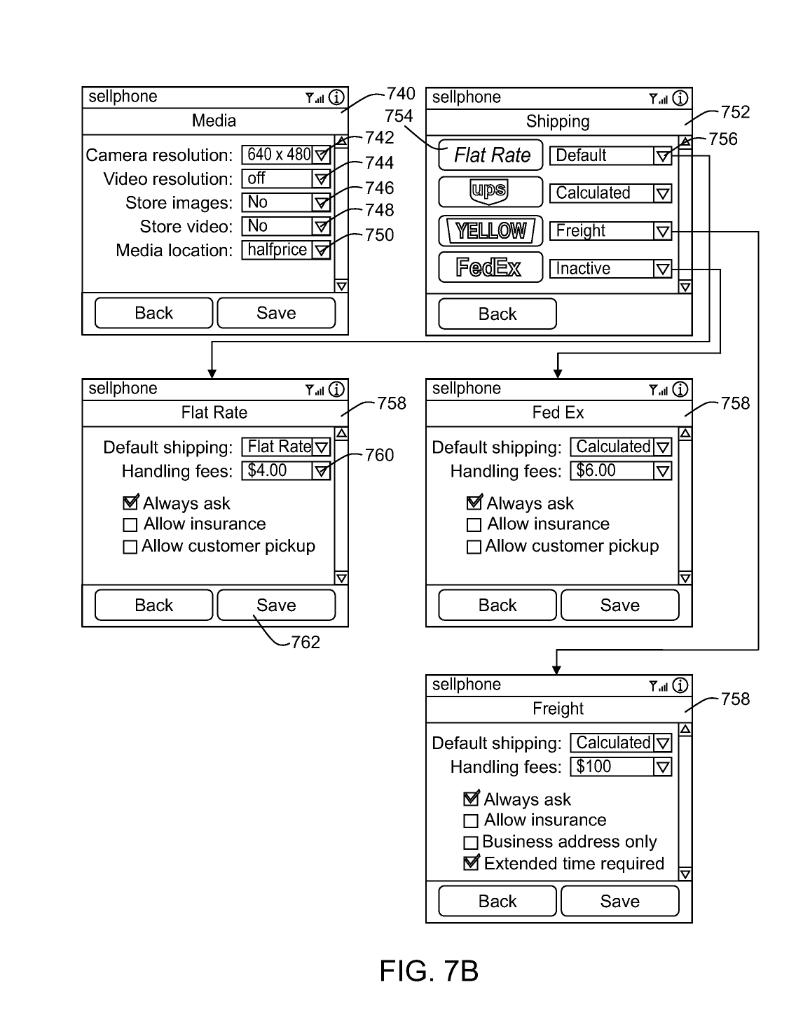

Returning to FIG. 5A, selection of the settings button 504d on the welcome screen launches a settings screen 702, as shown in FIGS. 7A and 7B, which provides for entry and selection of preferences for system elements. A “general” button 704a launches a general preferences screen 706 which identities and provides for modification of system preferences such as, for the exemplary embodiment shown, interface with the sales service provider's system using a drop down box 708 for preselected interface options. An ability to hide or show the description of listings is provided with a drop down box 710, listing title with drop down box 712, listing subtitle with dropdown box 714 and examples with drop down box 716. A selection of units of measure for the shipping and other system functions is provided in drop down box 718. Enabling or disabling message communication with the PDA by the sales service providers is established using drop down box 720. A “skin” or screen appearance is provided via drop down box 722. A button to change password 724 launches a password screen 726 which allows entry of password information and verification data.

A listings button 704b on the settings screen launches a listing locations screen 728 which identifies the sales service providers with which the PDA system is registered. The listing locations screen allows selection of and identifies the status of each provider as active or inactive and provides edit buttons 730 for modification of general data inputs specifically associated with each provider. As exemplary, provider screen 732 incorporates drop down boxes 734 for selection of default values for such values as auction duration; auto re-list, starting bid, reserve, make offer, retail value, subtitles, picture options, picture show, Gallery options and Text options. Similarly, alternate provider screens provide similar selection capability for each alternative provider.

A media button 704d on the settings screen launches a media options screen 740 which allows selection of properties for media to be used in association with the listing including camera resolution with a drop down box 742 and video resolution with drop down box 744 to allow the user to maximize storage. An option to store or not store images or video generated during development of listings is provided in drop down boxes 746 and 748. If media is not permanently stored on the PDA, transfer of the listing data generated in the listing process previously described will result in deletion of the associated media files for that listing in the PDA memory. For a sales provider with which media storage is provided with listings, a drop down box 750 for identification of that provider is available.

Finally on the settings screen a shipping button 704c is provided to launch a shipping screen 752. The shipping screen incorporates selectable identifiers 754 for multiple shipping entities with drop down boxes 756 for selection of shipping types assigned. Selection of the identifier for any shipping entity launches an entity screen 758 which provides detail information selectable by dropdown boxes 760 for shipping alternatives to be presented as a portion of prepared listing.

In each of the preferences screens a save button 762 is provided to save changes to the preferences entered on the screen.

Exemplary Computing Device

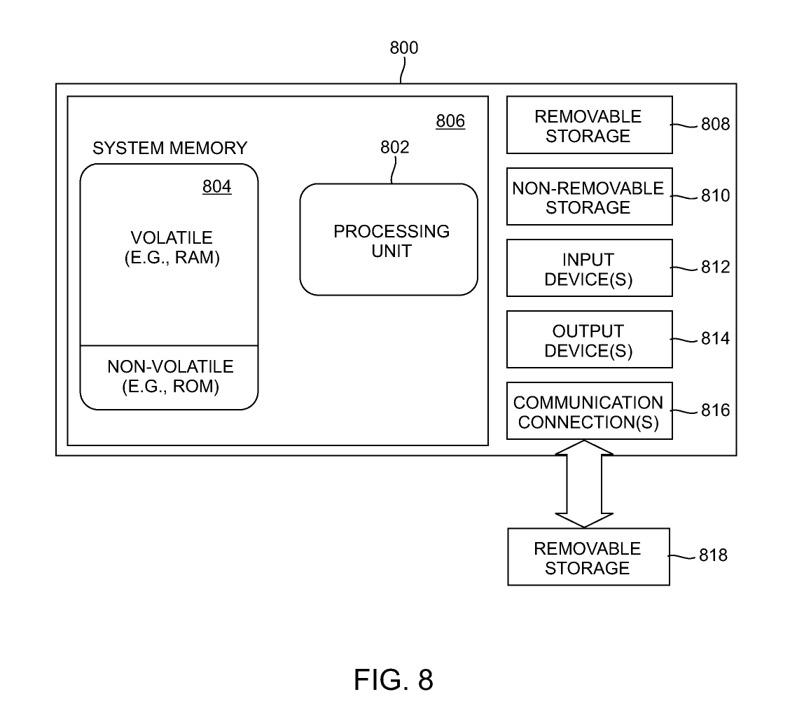

FIG. 8 is a functional block diagram generally illustrating a computing device 800, one or more of which can be adapted for use in the illustrative system presented below. The computing device 800 can be, for example, a personal computer, a handheld device such as a cell phone or a personal digital assistant, multi-processor systems, microprocessor-based or programmable consumer electronics, network PCs, minicomputers, mainframe computers and the like. A distributed computing environment where tasks are performed by remote processing devices 800 can be linked through a communications network. In a distributed computing environment, program modules can be located in both local and remote memory storage devices.

In its most basic configuration, computing device 800 typically includes at least one processing unit 802 and system memory 804. Depending on the exact configuration and type of computing device, system memory 804 can be volatile (such as RAM), non-volatile (such as ROM, flash memory, etc.), or some combination of the two. The basic configuration of the device 800 is illustrated in FIG. 8 within dashed line 806.

Device 800 can also have additional features and functionality. For example, device 800 can also include additional storage (removable and/or non-removable) including, but not, limited to, magnetic or optical disks or tape. Such additional storage is illustrated in FIG. 8 by removable storage 808 and non-removable storage 810. Computer storage media includes volatile and nonvolatile, removable and non-removable media implemented in any method or technology for storage of information such as computer readable instructions, data structures, program modules, or other data. Memory 804, removable storage 808, and non-removable storage 810 are examples of computer storage media. Computer storage media includes, but is not limited to, RAM, ROM. EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by device 800. Any such computer storage media can be part of device 800.

Device 800 can include one or more input devices 812 such as a keyboard, mouse, pen, voice input device, touch input device, scanner, or the like. One or more output devices 814 can also be included, such as a video display, audio speakers, a printer, or the like. Input and output devices are well known in the art and need not be discussed at length here.

Device 800 also contains communications connection 816 that allows the device 800 to communicate with other devices 818, such as over a local or wide area, network. Communications connection 816 is one example of communication media. Communication media includes any information delivery media that serves as a vehicle through which computer readable instructions, data structures, program modules, or other data can be delivered on a modulated data signal, such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, electromagnetic (e.g., radio frequency), infrared, and other wireless media. The term computer readable media as used herein includes both storage media and communication media.

Illustrative Networked Environment

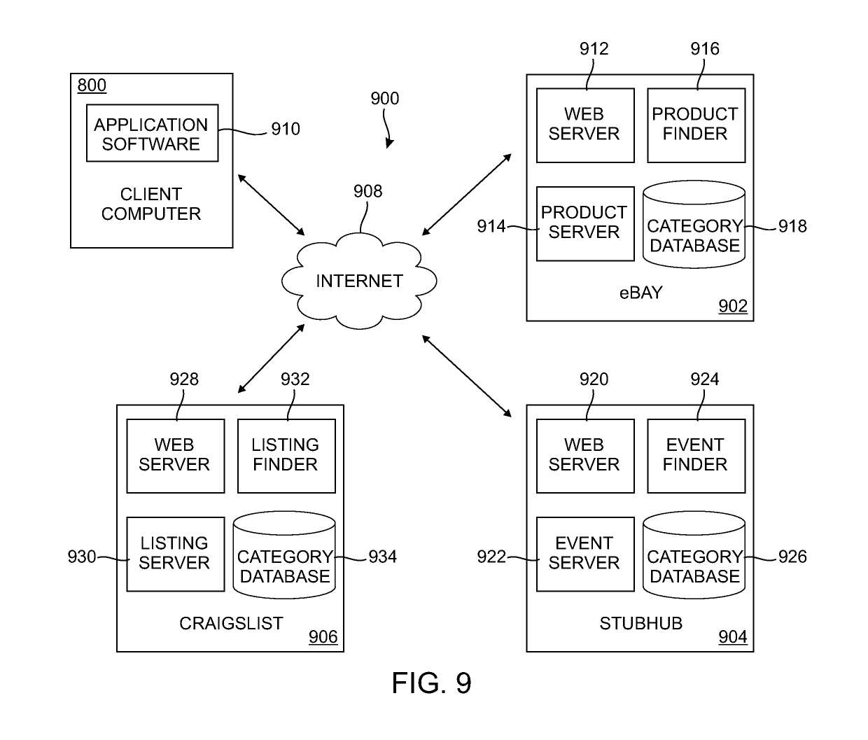

FIG. 9 is a functional block diagram generally illustrating an exemplary networked environment 900 for the device 800, having application software 910, to interact with online marketplaces and/or advertising websites to receive categories in the form of category trees as presented below. The environment can include a device 800, eBay auction agent 902, StubHub marketplace agent 904, and craigslist advertising agent 906, to name a few. Each of the components can be interconnected over a wide area network, such as the Internet 908. Although the following discussion will make reference to the Internet 908 as a specific wide area network, those skilled in the relevant art will appreciate that any mechanism for connecting multiple computing devices can equally be used.

As shown, the device 800 can be connected to the Internet 908 over a network connection, such as a dial-up modem connection or digital subscriber line connection. The device 800 can be adapted to interact with other computing devices over the Internet 908 through application software 910. The application software 910 can be integrated into a subsystem of an operating system executing on the device 800. Via the application software 910, a user of the device 800 can retrieve documents from other computing devices attached to the Internet 908, and can additionally provide information to those other computing devices.

In the exemplary networked environment 900, eBay auction agent 902 can include a web server 912, product server 914, product finder 916, and category database 918. Although these four components are shown, those skilled in the relevant art will appreciate that the functions of each described component can be merged into fewer components, or similarly, distributed among more components. The use of four illustrative components is for simplicity of discussion only, and should not be viewed as an exclusive list of components. Generally described, the web server 912 administers purchasing and listing transactions and interfaces with the device 800 via the Internet 908. The product server 914 can handle transactions received from the web server 912, while the product finder 916 locates products within eBay.

Categorical database 918 stores information about items that are auctioned off on eBay. General categories for eBay can include, but are not limited to, “Antiques,” “Art,” “Cell Phones & PDAs,” “Entertainment Memorabilia,” “Home & Garden,” “Music,” and “Video Games.” More specific categories for eBay can include, but are not limited to, “Bluetooth Accessories,” “Beads,” “Clocks,” “Motorcycles,” “Pet Supplies,” “Building Toys,” and “Internet games.”

The StubHub marketplace agent 904 can also have a network connection to the Internet 908 to interface with other computing devices also connected to the Internet 908. The StubHub marketplace agent 904 can include and maintain a web server 920 that administers purchasing and listing transactions and interfaces with the device 800 via the Internet 908. The event server 922 handles transactions received from the web server 920, while the event finder 924 locates specific events within StubHub.

The categorical database 926 stores information about tickets for events that can be provided by StubHub. General categories for StubHub can include, but are not limited to, “Sports,” “Concerts,” “Theater,” and “Exclusives.” In addition, StubHub provides specific categories that can include, but are not limited to, “Baseball,” “Hockey,” “Horse Racing,” “Green Day,” “No Doubt,” and “Jersey Boys.”

Similarly, craigslist advertising agent 906 includes a web server 928, listing server 930, listing finder 930, and categorical database 934. General categories for craigslist include, but are not limited to, “community,” “housing,” “for sale,” and “jobs.” More specific categories include, but are not limited to, “activities,” “vacation rentals,” and “accounting+finance. ”

While an eBay auction agent 902, StubHub marketplace agent 904, and craigslist advertising agent 906 have been described above, one skilled in the relevant art will appreciate that there are many other types of online marketplaces and advertising websites that can be provided within the environment 900. These can include, but are not limited to, Kijiji, amazon.com, Yahoo!, overstock.com, and DubLi.

In one embodiment, the categories provided above for each of the agents 902, 904, and 906 can be retrieved. Generally, both general and specific categories within each category database 918, 926, and 934 are retrieved through the web servers 912, 920, and 928 via the Internet 908. Alternatively, each of the categories can be determined by a manual method. Through this method, category trees can be visually seen on the websites provided by the web servers 912, 920, and 928 of each agent 902, 904, and 906.

Item Types

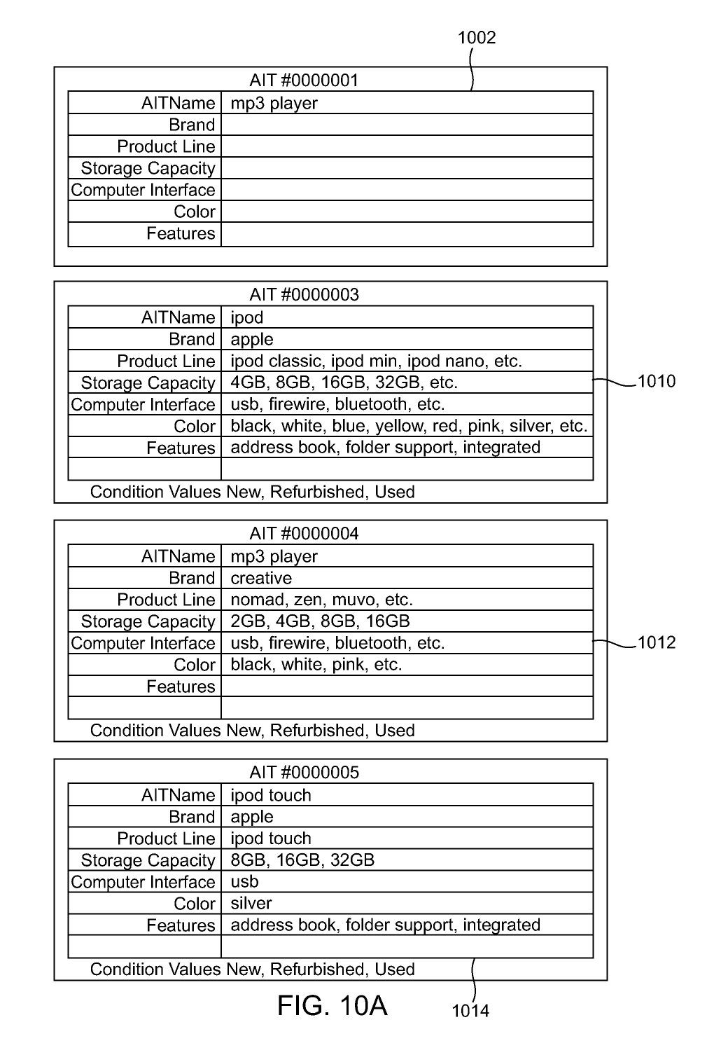

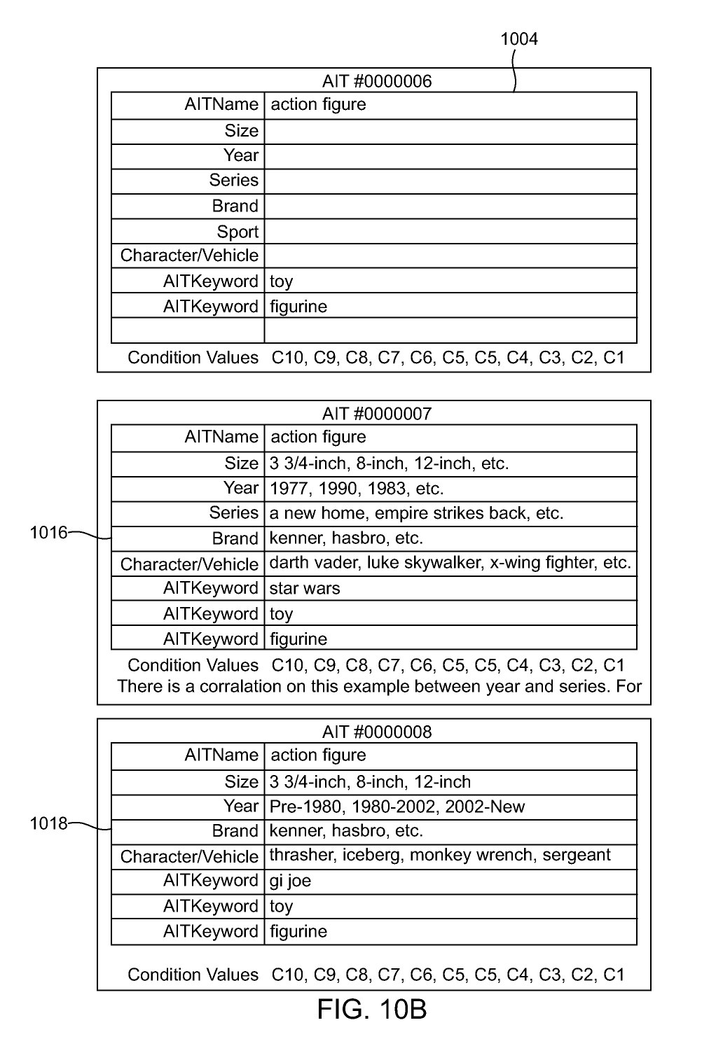

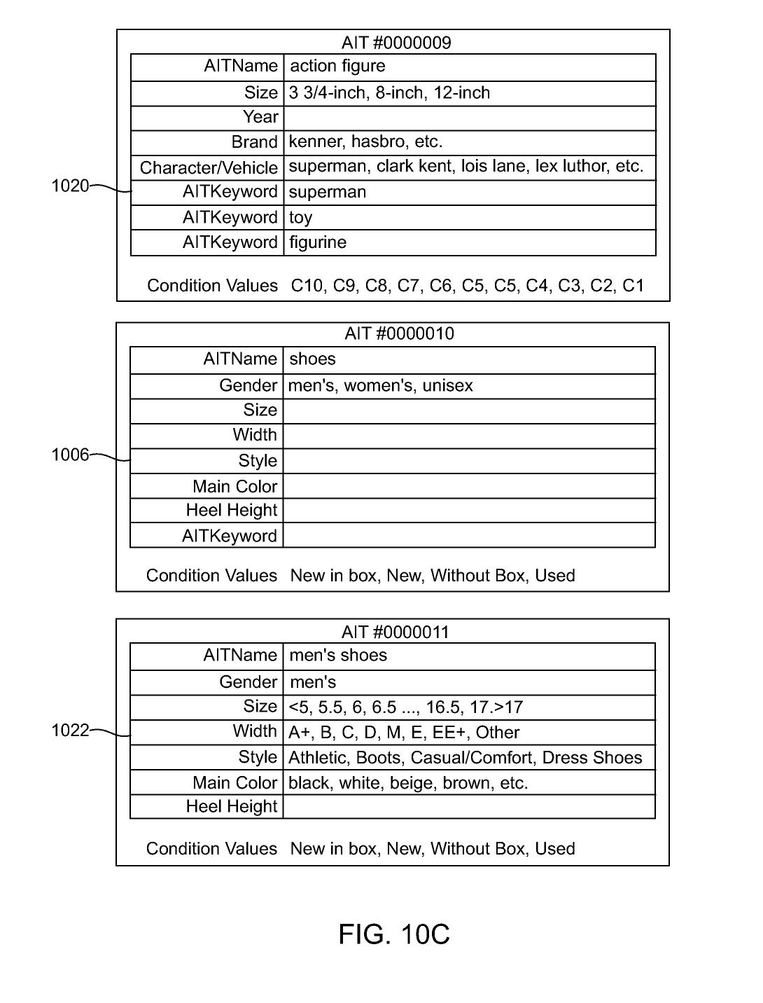

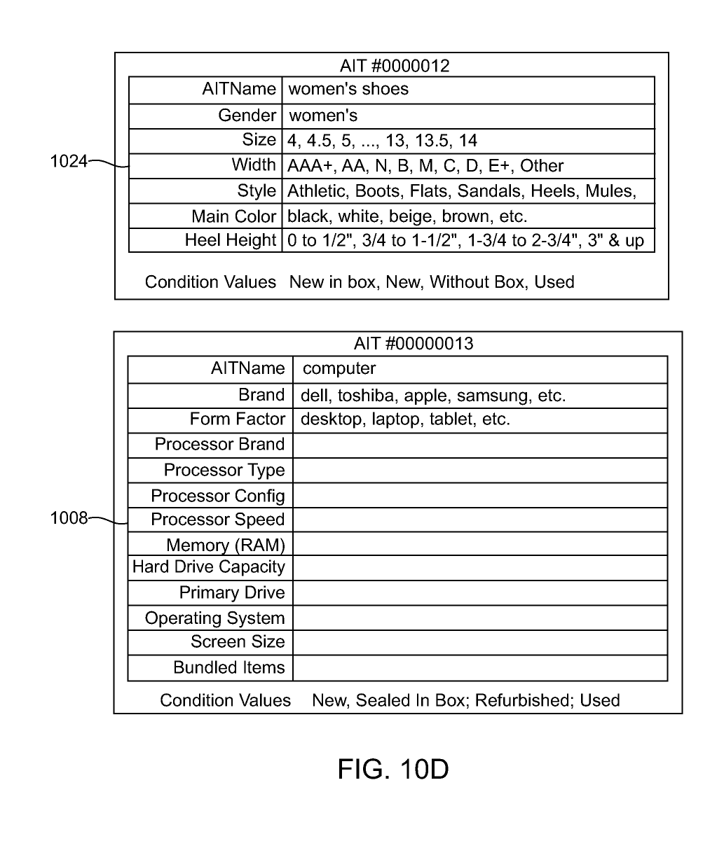

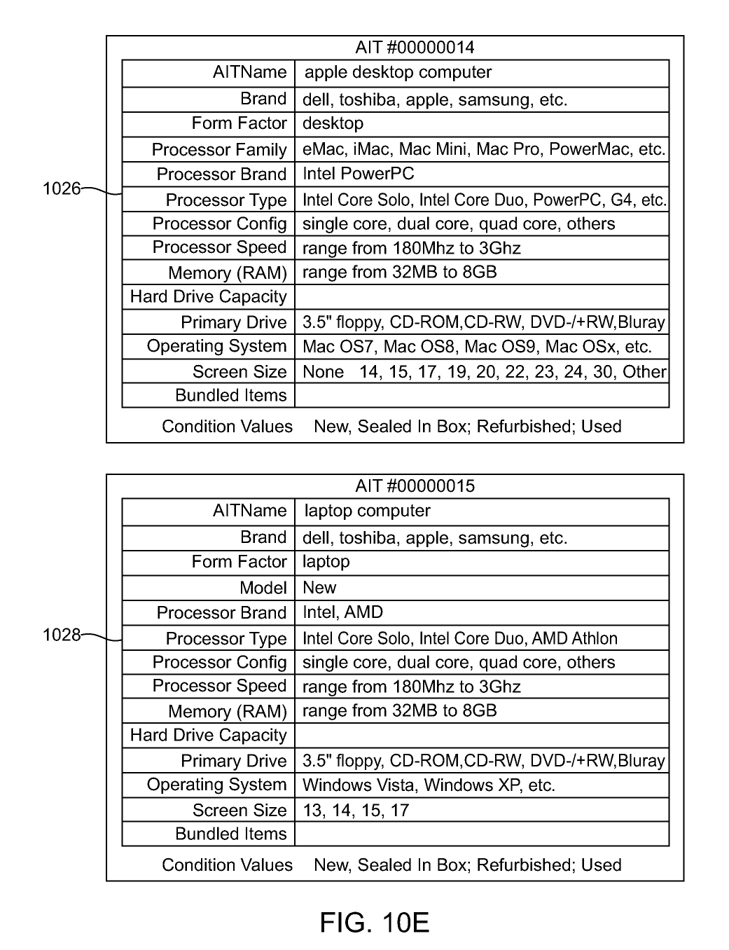

After receiving category trees from agents 902, 904, and 906, item types 1000 representing the categorical information from the trees can be generated as depicted in FIG. 10. Each item type 1000 includes a set of property/value pairs. For example, item type 1004, representing a generic item type, has a generic “action figure” name. In addition, the item type 1004 includes keywords, such as “Toy” and “Figurine,” and a series of properties that are inherent in some or all types of action figures. As shown, these properties can include “Size,” “Year,” “Series,” “Brand,” “Sport,” and “Character/Vehicle.” Noticeably, the item type 1004 has no values for the properties. Generally, the item types 1000 at the top represent generic item types 1002, 1004, 1006 and 1008.

Typically, below each generic item type 1002, 1004, 1006 and 1008 are specific item types 1010, 1012, 1014, 1016, 1018, 1020, 1022, 1024, 1026, and 1028. By having both generic item types 1002, 1004, 1006 and 1008 and specific item types 1010, 1012, 1014, 1016, 1018, 1020, 1022, 1024, 1026, and 1028 a two-tiered structure is formed. Through this two-tiered structure, processing and submission of data is more efficient.

With continuing reference to FIG. 10, the specific item types 1010, 1012, 1014, 1016, 1018, 1020, 1022, 1024, 1026, and 1028 not only incorporate the name of the generic item types 1002, 1004, 1006 and 1008 which they depend on, but they also include the same keywords and properties. In addition, additional keywords with more or less properties can be provided. Importantly, values associated with the properties can be added. Some properties are required while others are optional.

Continuing with the “action figure” example provided above, specific item type 1016 depicts a “Star Wars action figure.” Associated with specific item type 1016 is the keyword “Star Wars.” In addition, a specific set of values tbr the properties “Size,” “Year,” “Series,” “Brands,” and “character/vehicles,” all of which are Star Wars-specific, are provided. Normally, specific item types 1010, 1012, 1014, 1016, 1018, 1020, 1022, 1024, 1026, and 1028 can have required fields. The fields are based on categories supplied by agents 902, 904, and 906 through their category trees, both generic and specific. In specific item type 1016, the “Series” property is required to categorize an “action figure.”

As re-emphasized here, generic item types 1002, 1004, 1006 and 1008 are associated with specific item types 1010, 1012, 1014, 1016, 1018, 1020, 1022, 1024, 1026, and 1028. The name, keywords, and properties of the generic item types 1002, 1004, 1006 and 1008 are similarly incorporated within the specific item types 1010, 1012, 1014, 1016, 1018, 1020, 1022, 1024, 1026, and 1028. As shown in FIG. 10, specific item types 1010, 1012 and 1014 are dependent on generic item type 1002 and carry similar features. Specific item types 1016, 1018 and 1020 are dependent on generic item type 1004 and carry similar features. Specific item types 1022 and 1024 are dependent on generic item type 1006 and carry similar features. Specific item types 1026 and 1028 are dependent on generic item type 1008 and carry similar features. As shown, the generic item types 1002, 1004, 1006 and 1008 are above the specific item types 1010, 1012, 1014, 1016, 1018, 1020, 1022, 1024, 1026, and 1028 creating a two-tiered structure.

In one embodiment, the qualification for an item type 1000 would be that it is limited to an actual item (or service) that can be sold, and not just a classification. For example, eBay uses “Everything Else” as their catch-all high-level category. Because there is not category type of “everything else,” the device described herein would consider this to be an invalid item type.

### EXAMPLES

In order to provide a clearer understanding of the item types 1000 described above, some examples will be provided. These examples are not to be construed as limiting to the scope of the present application, but instead provide simple illustrations of the correspondence between eBay categories and the item types 1000. Sample eBay categories can be found at http://listings.ebay.com.

To effectively categorize a Star Wars “action figure” using eBay categories, item type 1016 includes properties of episode, movie, and series that the action figure comes from. As shown below, eBay includes the following similar categories for Star Wars “action figures”:

Toys & Hobbies > Action Figures > TV, Movie & Video
Games > Star Wars > Episodes 4-6 (1977-1989) > Star Wars:
A New Hope
Toys & Hobbies > Action Figures > TV, Movie & Video
Games > Star Wars > Episodes 1-3 (1999-2005) > The
Phantom Menace

Item type 1018 having “GI Joe” under keywords is also an “action figure” under the generic item type 1004. Item type 1018 has the properties of sizes, but has different year ranges. Both of these fields are required. As shown below, eBay includes the following similar categories for “action figures”:

“Toys & Hobbies > Action Figures > Military & Adventure >
GI Joe > 3 3/4-inch > 1980-2002”

“Toys & Hobbies > Action Figures > Military & Adventure
> GI Joe > 12-inch > Pre-1980”

Continuing, item type 1020, the “Superman action figure,” has one corresponding eBay category which includes the following:

“Toys & Hobbies > Action Figures > Comic Book Heroes >
Superman”

Because there are no specific properties embedded in the eBay category tree, there are no required attributes for Superman action figures.

While Loop

To fill in specific item types 1010, 1012, 1014, 1016, 1018, 1020, 1022, 1024, 1026, and 1028 a while loop can be used. One skilled in the relevant art will appreciate that a while loop is repeated when a certain condition is true. Preferably, the while loop is written in a block of XML code. The while loop, as shown in one embodiment below, cycles through the list of required properties for an item type 1000.

The while loop can be written as:

| <While Condition=“IncompleteAIT”> | |
|---|---|
| <Property Type=“Required”> | |
| <Question> | |
| <Choice | Condition=“FirstUse”> <![CDATA[What |

%%PropertyName%% is
it?]]> </Choice>
<Choice Condition=“Default”> <![CDATA[What's the
%%Property Name%%?]]> </Choice>
<Choice Condition=“Default”> <![CDATA[How bout the
%%PropertyName%%?]]> </Choice>
<Choice Condition=“Default”> <![CDATA[The
%%PropertyName%%?]]> </Choice>
<Choice
Condition=“Default”> <![CDATA[%%PropertyName%%?]]>
</Choice>
</Question>
<Answer>
<Required>true</Required>
</Answer>
</Property>
<Pause/>
</While>

Methods of Operation

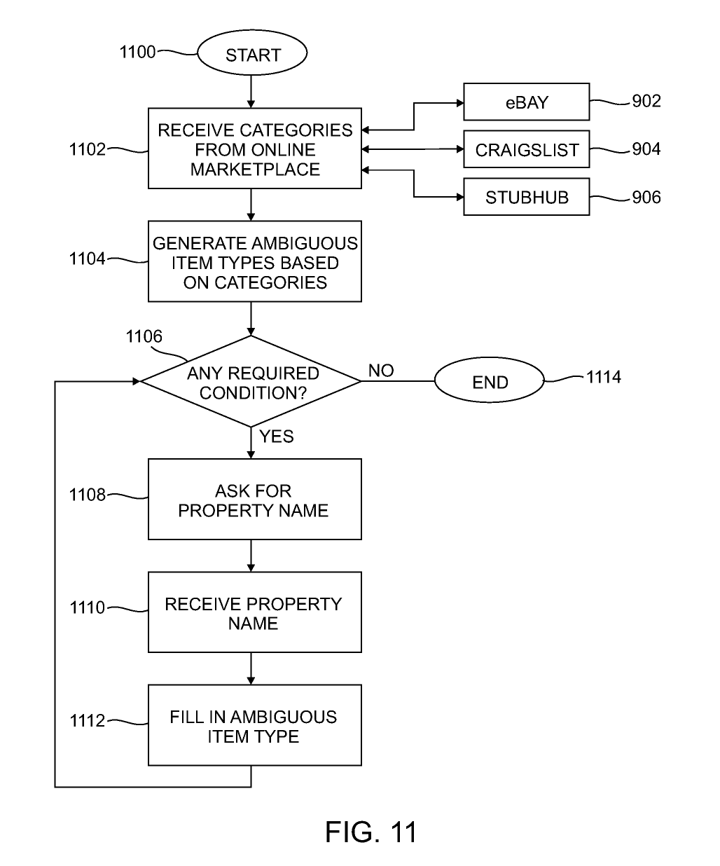

FIG. 11 is an exemplary flow chart for generating and filling in categorical-based item types in accordance with one aspect of the present application. The method begins at block 1100. At block 1102, the device 800 receives categories from the online market place and/or online advertising websites. Typically, these can be in the form of category trees. To receive these category trees, a user of device 800 can manually retrieve the category trees. Alternatively, device 800 can automatically retrieve the category trees. As shown, the category trees are received from the eBay auction agent 902, StubHub marketplace agent 904, and craigslist advertising agent 906. One skilled in the relevant art will appreciate that there are other category trees by other agents.

At block 1104, device 800 generates item types 1000 as described above. In other embodiments, the item types 1000 can be generated on the agent.

At determination block 1106, device 800 determines whether there is any required condition that needs to be filled within the item type 1000. At block 1108, device 800 asks for the property name when there is a required condition. Device 800 receives the property name at block 1110. At block 1112, the user of device 800 fills in the item type 1000 and control is returned to determination block 1106 to decide whether there are any other required conditions.

When there are no other required conditions at determination block 1106, the method ends at block 1114. When a further analysis of the loop is performed, and when the user is asked for the property name at block 1108, a required value does not necessarily need to be entered. Instead an optional value can be entered. The loop will continue looping until all required values have been entered. In other embodiments, after all the required conditions have been entered, device 800 can receive optional values as well.

Multi-Tiered Item Types

In the embodiments provided above, a two-tiered structure was provided. As shown in the FIGURES provided in ATTACHMENT F, the item types 1000 can have multiple tiers of parent-child relationships with each child dependent on their parent. Furthermore, siblings can be provided for, the siblings including those item types 1000 that are related to each other, but do not necessarily have the same properties. “Physical Item,” “Service,” or “Digital Item” can be siblings. Generally, each of these would have different properties associated with them and those properties would be propagated to each of their children.

Within the multi-tiered item types 1000, the depth of an item type 1000 can be determined using three factors. These factors include: (1) the prevalence of user searches; (2) the benefit to the user experience; and (3) the enrichment of data. One skilled in the relevant art will appreciate that these factors are not limiting, but should rather be construed as illustrative for the purposes of the present application.

The depth of an item type 1000 can be determined by the prevalence of user searches. In other words, the depth of the item type 1000 can correspond to typical searches made by users. For example it is possible to have an item type 1000 called “1978 U.S. Washington Quarter,” though that could mean that similar item types 1000 should be created for each year and bust combination. Instead, users will more likely search for “Washington Quarter” or simply “Quarter,” so those are the item types 1000 that should be generated.

Item types 1000 and the depth of the item types 1000 are also determined by the benefit to the user experience. If the addition of a child item type 1000 narrows down or fine tunes enough data in the user interface, then its creation is warranted. In the case of the “Washington Quarter” item type 1000, the Bust is narrowed down to one option, and the Year is narrowed from a minimum of 1796 to 1938. Adding a “1978 Washington Quarter” item type 1000 would only eliminate one step for the user, and same thing can be accomplished without the creation of a new item type 1000. The benefit of adding a new item type 1000 is to minimize the overhead of performing lookups, as well as to provide more accurate data for an item.

The depth of the item type 1000 can also be dependent on the enrichment of data. In the Star Wars Action Figure case below, an Episode property is added, which is a critical piece of data in the marketing and pricing of a particular action figure. Without the presence of a Star Wars-specific item type 1000, this data would be lost.

With reference now to FIG. 1 of ATTACHMENT F, a root item type 1000, titled “Physical Item,” has the properties of dimension, weight, and value. The root item type 1000 can represent a generic item type 1000 as discussed above. A child item type 1000, or specific item type 1000, dependent on the “Physical Item” can be “Coin,” as shown in FIG. 2 of ATTACHMENT F, which holds properties common to all coins. As shown, the properties are inherited from the parent, “Physical Item,” and ranges can be assigned to those properties.

Children of “Coin” could be “U.S. Quarter” and “U.S. Nickel,” as shown in FIGS. 3 and 4 of ATTACHMENT F. A quarter can have specific ranges of property values. Once an item has been identified as a “U.S. Quarter,” all that is needed to be requested from the user is the year (narrowed down to a specific range) and the bust (narrowed down to a list of valid options).

As depicted in FIG. 5 of ATTACHMENT F, one step further could be the “Washington Quarter,” which eliminates all ambiguity except for the year the coin was minted.

FIG. 6 of ATTACHMENT F illustrates another child of “Physical Item,” the child being “Action Figure.” The length, width, height, and weight of the

“Action Figure” is represented by “<24 in,” “<24 in,” “<24 in,” and “<10 lb,” respectively. A child of the “Action Figure” could be a “Star Wars Action Figure” item type 1000, as provided for in FIG. 7 of ATTACHMENT F. The “Star Wars Action Figure” item type 1000 inherits the properties from its parent, but also adds an additional property “Episode.” The “Joe Action Figure” item type simply inherits the same properties as its parent as shown in FIG. 8 of ATTACHMENT F.

Aspects of the Present Application

In accordance with one aspect of the present application, a system for categorizing information about an item for use by an online marketplace or online advertising website is presented. The system includes at least one processor and a database for storing item types associated with a plurality of categories from a number of online marketplaces and online advertising websites. Each item type is general or specific and has property/value pairs, with the property/value pairs being either required or optional. In addition, the system includes a memory operatively coupled to the processor. The memory stores program instructions, that when executed by the processor, causes the processor to perform routines.

These routines can include receiving categorical information from the online marketplaces and online advertising websites and generating item types by using the received categorical information and storing them in the database, the item types separated into a two-tier structure with generic item types at the first tier and specific item types at the second tier.

For any new listing, the routines determine whether there are any required properties for the item type and, if so, request and receive a value associated with a property for each required property/value pair. In addition, the routines request for and receive values associated with properties for optional property/value pairs. Furthermore, the routines generate a specific item type to send to the online marketplaces and online advertising websites using the required and optional property/value pairs for each new listing and associate the specific item type to a generic item type.

In accordance with another aspect of the present application, a computer-implemented method for categorizing an item is presented. The method includes establishing generic item types. In addition, the method includes establishing specific item types associated with a generic item type. All specific item types associated with the generic item type include characteristics of the generic item type. The characteristics are based on categories from online marketplaces and online advertising websites. Specific values associated with the characteristics are unique to each specific item type.

In accordance with still yet another aspect of the present application, a computer readable medium storing instructions for causing at least one processor to perform a method that generates item types for posting to an online server is presented. The method includes receiving a category tree from the online server, the category tree describing general and specific categories in which items can be classified. In addition, the method includes establishing item types based on the general and specific categories described by the category tree, wherein the item types can be either generic item types or specific item types, the specific item types having required fields. Furthermore, for each required field within a specific item type, the method includes requesting and receiving values for the required field.

In one embodiment, fields for specific item types are Star Wars specific. The specific item types can have fields of size, year, series (movie), brand, and character/vehicles. In one embodiment, the category tree is from eBay. In another embodiment, the category tree is from Kijiji. In yet another embodiment, the category tree is from craigslist. In still yet another embodiment, the category tree is from StubHub.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

While the present invention has been described with regards to particular embodiments, it is recognized that additional variations of the present invention may be devised without departing from the inventive concept.

What is claimed is:

1. A system for categorizing information about an item for use by an online marketplace or online advertising website, the system comprising:
at least one processor;
a database for storing item types associated with a plurality of categories from a number of online marketplaces and online advertising websites, wherein each item type is general or specific and has property/value pairs, the property/values either being required or optional;
a memory operatively coupled to the processor, the memory storing program instructions that when executed by the processor, cause the processor to:
receive categorical information from the online marketplaces and online advertising websites;
generate item types by using the received categorical information and storing them in the database, the item types separated into a two-tier structure with generic item types at the first tier and more specific item types at the second tier;
for any new listing:
determine whether there are any required property/value pairs and if so request for and receive a value associated with a property for each required property/value pair;
request for and receive values associated with properties for optional property/value pairs; and
generate a specific item type to send to the online marketplaces and online advertising websites using the required and optional property/value pairs for each new listing and associate the specific item type to a generic item type.

2. A computer-implemented method for categorizing an item, the method comprising:
establishing generic item types; and
establishing specific item types associated with a generic item type, wherein all specific item types associated with the generic item type include characteristics of the generic item type, the characteristics based on categories from online marketplaces and online advertising websites and specific values associated with the characteristics being unique to each specific item type.

3. A computer readable medium storing instructions for causing at least one processor to perform a method that generates item types for posting to an online server, the method comprising:
receiving a category tree from the online server, the category tree describing general and specific categories in which items can be classified;
establishing item types based on the general and specific categories described by the category tree, wherein the item types can be either generic item types or specific item types, the specific item types having required fields; and
for each required field within a specific item type, requesting and receiving values for the required field.

4. The method of claim 3, wherein fields for a specific item type are Star Wars specific.

5. The method of claim 4, wherein the specific item type has fields of size, year, series (movie), brand, and character/vehicles.

6. The method of claim 3, wherein the category tree is from eBay.

7. The method of claim 3, wherein the category tree is from Kijiji.

8. The method of claim 3, wherein the category tree is from craigslist.

9. The method of claim 3, wherein the category tree is from StubHub.
